(19) United States
(12) Patent Application Publication
(10) Pub. No.: US 2016/0027011 A1
(43) Pub. Date: Jan. 28, 2016

(54) TRANSACTION TERMINAL DEVICE, TRANSACTION PROCESSING METHOD, AND TRANSACTION PROCESSING SYSTEM

(71) Applicant: PANASONIC INTELLECTUAL PROPERTY MANAGEMENT CO., LTD., Osaka (JP)

(72) Inventors: Takeshi NINOMIYA, Osaka (JP); Yoshihide NAKASHIMA, Fukuoka (JP)

(73) Assignee: PANASONIC INTELLECTUAL PROPERTY MANAGEMENT CO., LTD., Osaka (JP)

(21) Appl. No.: 14/807,147

(22) Filed: Jul. 23, 2015

(30) Foreign Application Priority Data
Jul. 24, 2014 (JP) 2014-151081
Jul. 24, 2014 (JP) 2014-151096

(51) Int. Cl. G06Q 20/40; G06Q 20/38

(52) U.S. Cl. CPC G06Q 20/401; G06Q 20/3821; G06Q 20/3825

(57) ABSTRACT

A transaction terminal device connected to a settlement destination device includes a non-secure first information processing unit, and a secure second information processing unit. The first information processing unit includes a settlement processing unit that performs a transaction settlement process, and a certificate request transmitting unit that transmits a request for a certificate indicating regularity of the settlement destination device to the settlement destination device. The second information processing unit includes a signature verifying unit that verifies legality of a signature obtained by encrypting at least a part of a program code for operating the settlement processing unit. The certificate request transmitting unit transmits the request for the certificate to the settlement destination device when the legality of the signature is verified by the signature verifying unit. The settlement processing unit performs a settlement process between the settlement destination device and the transaction terminal device by using the certificate.

### BACKGROUND OF THE INVENTION

1. Field of the Invention

The present invention relates to a transaction terminal device, a transaction processing method, and a transaction processing system that are used to perform a procedure of a settlement process in a transaction.

2. Description of the Related Art

For example, in credit transaction of goods or services using a credit card, security of the credit transaction is ensured by confirming (identity verification) whether or not a person who conducts the credit transaction and a possessor of the credit card used for the credit transaction are the same person. The identity verification is performed by signing a signature by a client on a transaction slip on which the transaction content is printed at the time of a settlement process of the credit transaction and comparing this signature with a signature shown on the credit card by a clerk through a visual check.

In recent years, a transaction terminal device capable of inputting and displaying such a signature has been implemented using a smart phone or a tablet terminal. Many smart phones or tablet terminals can be used as transaction terminal devices by being distributed as devices for consumers and being supplied at low prices. That is, the transaction terminal devices can be supplied at low prices as long as many information communication terminals distributed for consumers such as smart phones or tablet terminals can be used as the transaction terminal devices. If development platforms of applications used for a settlement process or applications used for other tasks other than the settlement process can be generalized, it is easy to reuse or apply development resources thereof. For this reason, these applications are installed in a storage area having high versatility in many cases.

However, the information communication terminals (for example, smart phones or tablet terminals) designed so as to be used as devices for consumers do not have “tamper resistance” required to safely perform the transaction by protecting important information (for example, personal information) regarding a client. “Tamper resistance” refers to resistance to attacks that try to steal information from the information communication terminal or attacks that try to install illegal applications.

In U.S. Patent Unexamined Publication No. 2010/0145854 and Japanese Patent Unexamined Publication No. 2008-288744, in order to secure the tamper resistance as a countermeasure of the attacks that try to steal the information from the information communication terminal or the attacks that try to install the illegal applications, a mobile device in which a portion (referred to as a “secure portion” in U.S. Patent Unexamined Publication No. 2010/0145854; the secure portion is a portion requiring the tamper resistance as the transaction terminal device.) related to authentication information of a credit card used for the settlement process is physically separated from a general portion has been suggested.

However, in an information processing device used in the settlement process, security of important information of the client used in the settlement process is sufficiently ensured in the secure portion, but security of information is not sufficiently ensured in a non-secure portion.

For this reason, when an illegal application is installed in the non-secure portion by a man-in-the-middle attack of a third person with malice, there is a possibility that unexpected damage will occur to both the client and the member store. For example, the unexpected damage to the client means that authentication information (for example, personal identification number (PIN) or signature) used for identity verification of the client is stolen by the illegal application. The unexpected damage to the member store means that an illegal sale is conducted. For example, when the member store sells goods or provides services to a counterparty that does not originally get credit, the illegal sales incur a loss in which it is difficult to collect money to be paid for the goods or services.

Meanwhile, for example, when a contract is concluded such that an acquirer (company that concludes contracts with member stores which conduct transactions using a specific credit card and manages credit sales) compensates for a loss of a member store between the member store and the acquirer or between the member store and a processor (company that accepts task entrustment from the acquirer and mediates settlement), a loss consequently occurs not for the member store but for the acquirer or the processor.

### SUMMARY OF THE INVENTION

An object of the present disclosure is to provide a transaction terminal device, a transaction processing method, and a transaction processing system that appropriately determine whether or not to connect to a connection destination device.

More specifically, an object of the present disclosure is to provide a transaction terminal device, a transaction processing method, and a transaction processing system that determine whether or not to obtain a settlement service certificate for guaranteeing the reliability of a connection destination device of a settlement application depending on a verified result of the regularity of a signature assigned to a settlement application and appropriately determine whether or not to connect to the connection destination device depending on whether or not the settlement service certificate is present.

More specifically, an object of the present disclosure is to provide a transaction terminal device, a transaction processing method, and a transaction processing system that determine whether or not to transmit a settlement client certificate for guaranteeing the reliability of a connection request source with respect to a connection destination device of a settlement application depending on a verified result of the regularity of a signature assigned to the settlement application, appropriately determine whether or not to connect to the connection destination device, and control connection to an illegal member store terminal.

According to the present disclosure, there is provided a transaction processing system that includes a transaction terminal device, and a settlement destination device that is connected to the transaction terminal device, in which the transaction terminal device includes a non-secure first information processing unit that does not have tamper resistance, and a secure second information processing unit that has tamper resistance, the settlement destination device includes a communication unit that transmits a certificate indicating regularity of the settlement destination device to the transaction terminal device in response to a request from the transaction terminal device, the first information processing unit includes a settlement processing unit that performs a transaction settlement process, and a certificate request transmitting unit that transmits a request for the certificate to the settlement destination device, the second information processing unit includes a signature verifying unit that verifies legality of a signature obtained by encrypting at least a part of a program code for operating the settlement processing unit, and the certificate request transmitting unit transmits the request for the certificate to the settlement destination device when the legality of the signature is verified by the signature verifying unit, and the settlement processing unit performs a settlement process between the settlement destination device and the transaction terminal device by using the certificate transmitted from the settlement destination device.

According to the present disclosure, there is provided a transaction processing method in a transaction processing system that includes a transaction terminal device which performs a transaction settlement process and a settlement destination device which is connected to the transaction terminal device, the method including: causing the transaction terminal device to include a non-secure first information processing unit that does not have tamper resistance and a secure second information processing unit that has tamper resistance; causing the transaction terminal device to execute a step of verifying legality of a signature obtained by encrypting at least a part of a program code of the settlement process in the second information processing unit, and a step of transmitting a request for a certificate indicating regularity of the settlement destination device to the settlement destination device in the first information processing unit when the legality of the signature is verified in the second information processing unit; causing the settlement destination device to execute a step of transmitting the certificate to the transaction terminal device in response to the request from the transaction terminal device; and causing the transaction terminal device to further execute a step of performing a settlement process between the settlement destination device and the transaction terminal device in the first information processing unit by using the certificate transmitted from the settlement destination device.

According to the present disclosure, there is provided a transaction terminal device that is connected to a settlement destination device, the device including: a non-secure first information processing unit that does not have tamper resistance; and a secure second information processing unit that has tamper resistance, in which the first information processing unit includes a settlement processing unit that performs a transaction settlement process, and a certificate request transmitting unit that transmits a request for a certificate indicating regularity of the settlement destination device to the settlement destination device, the second information processing unit includes a signature verifying unit that verifies legality of a signature obtained by encrypting at least a part of a program code for operating the settlement processing unit, and the certificate request transmitting unit transmits the request for the certificate to the settlement destination device when the legality of the signature is verified by the signature verifying unit, and the settlement processing unit performs a settlement process between the settlement destination device and the transaction terminal device by using the certificate transmitted from the settlement destination device in response to the request.

According to the present disclosure, it is possible to appropriately determine whether or not to connect to the connection destination device.

More specifically, according to the present disclosure, it is possible to determine whether or not to obtain the settlement service certificate for guaranteeing the reliability of the connection destination device of the settlement application depending on the verified result of the regularity of the signature assigned to the settlement application, and it is possible to appropriately determine whether or not to connect to the connection destination device depending on whether or not the settlement service certificate is present.

According to the present disclosure, there is provided a transaction processing system that includes a transaction terminal device, and a settlement destination device connected to the transaction terminal device, in which the transaction terminal device includes a non-secure first information processing unit that does not have tamper resistance, and a secure second information processing unit that has tamper resistance, the settlement destination device includes a communication unit that performs the settlement process between the transaction terminal device and the settlement destination device in response to a connection request including a certificate indicating regularity of a connection request source with respect to the settlement destination device from the transaction terminal device, the first information processing unit includes a settlement processing unit that performs a transaction settlement process, and a certificate transmission processing unit that transmits the certificate to the settlement destination device, the second information processing unit includes a signature verifying unit that verifies legality of a signature obtained by encrypting at least a part of a program code for operating the settlement processing unit, and the certificate transmission processing unit transmits the certificate to the settlement destination device when the legality of the signature is verified by the signature verifying unit, and the settlement processing unit receives a response result from the settlement destination device in response to the certificate and performs a settlement process between the settlement destination device and the transaction terminal device.

According to the present disclosure, there is provided a settlement processing method in a transaction processing system that includes a transaction terminal device which performs a transaction settlement process, and a settlement destination device which is connected to the transaction terminal device, the method including: causing the transaction terminal device to include a non-secure first information processing unit that does not have tamper resistance and a secure second information processing unit that has tamper resistance; and causing the transaction terminal device to execute a step of verifying legality of a signature obtained by encrypting at least a part of a program code of the settlement process in the second information processing unit, a step of transmitting a certificate indicating regularity of a connection request source with respect to the settlement destination device to the settlement destination device in the first information processing unit when the legality of the signature is verified in the second information processing unit, and a step of receiving a response result from the settlement destination device in response to the certificate and performing a settlement process between the settlement destination device and the transaction terminal device.

According to the present disclosure, there is provided a transaction terminal device that is connected to a settlement destination device, the device including: a non-secure first information processing unit that does not have tamper resistance; and a secure second information processing unit that has tamper resistance, in which the first information processing unit includes a settlement processing unit that performs a transaction settlement process, and a certificate transmission processing unit that transmits a certificate indicating regularity of a connection request source with respect to the settlement destination device to the settlement destination device, the second information processing unit includes a signature verifying unit that verifies a signature obtained by encrypting at least a part of a program code of the settlement process, and the certificate transmission processing unit transmits the certificate to the settlement destination device when the legality of the signature is verified by the signature verifying unit, and the settlement processing unit receives a response result from the settlement destination device in response to the certificate and performs a settlement process between the settlement destination device and the transaction terminal device.

According to the present disclosure, it is possible to appropriately determine whether or not to connect to the connection destination device.

More specifically, according to the present disclosure, it is possible to determine whether or not to transmit the settlement client certificate for guaranteeing the reliability of the connection request source with respect to the connection destination device of the settlement application depending on the verified result of the regularity of the signature assigned to the settlement application, it is possible to appropriately determine whether or not to connect to the connection destination device, and it is possible to control connection to an illegal member store terminal.

### BRIEF DESCRIPTION OF DRAWINGS

FIG. 1 is a schematic diagram showing the connection relationship between a transaction terminal device of a member store, a processor device of an acquirer or a third party and a signature generating device of a manufacturer of a transaction terminal device at the time of a settlement process;

FIG. 2 is a schematic diagram showing a first example of the connection relationship between the transaction terminal device of the member store, the processor device of the acquirer or the third party and the signature generating device of the manufacturer of the transaction terminal device at the time of installing a settlement application;

FIG. 3 is a schematic diagram showing a second example of the connection relationship between the transaction terminal device of the member store, the processor device of the acquirer or the third party and the signature generating device of the manufacturer of the transaction terminal device at the time of installing the settlement application;

FIG. 4A is a front view of the transaction terminal device according to Exemplary Embodiment 1;

FIG. 4B is a side view of the transaction terminal device shown in FIG. 4A;

FIG. 5 is a block diagram showing an example of a hardware configuration of the transaction terminal device according to Exemplary Embodiment 1;

FIG. 6 is an explanatory diagram showing data and the outline of a process flow at the time of installing the settlement application corresponding to FIG. 2;

FIG. 7 is a flowchart for describing an operation procedure of installing the settlement application corresponding to FIG. 2;

FIG. 8 is an explanatory diagram showing data and the outline of a process flow at the time of installing the settlement application corresponding to FIG. 3;

FIG. 9 is a flowchart for describing an operation procedure of installing the settlement application corresponding to FIG. 3;

FIG. 10 is an explanatory diagram showing a first example of an operation outline regarding the verification of the D signature, and the request and acquisition of a settlement service certificate in the transaction terminal device according to Exemplary Embodiment 1;

FIG. 11 is a block diagram showing a first example of a functional software configuration of the transaction terminal device according to Exemplary Embodiment 1;

FIG. 12 is a flowchart for describing an example of the verification of the D signature, the request and acquisition of the settlement service certificate, and the operation procedure of the settlement process in the transaction terminal device corresponding to FIG. 11;

FIG. 13 is a block diagram showing a second example of a functional software configuration of the transaction terminal device according to Exemplary Embodiment 1;

FIG. 14 is a flowchart for describing an example of the verification of the D signature, the request and acquisition of the settlement service certificate, and the operation procedure of the settlement process in the transaction terminal device corresponding to FIG. 13;

FIG. 15 is a block diagram showing a third example of a functional software configuration of the transaction terminal device according to Exemplary Embodiment 1;

FIG. 16 is a flowchart for describing an example of the verification of the D signature, the request and acquisition of the settlement service certificate, and the operation procedure of the settlement process in the transaction terminal device corresponding to FIG. 15;

FIG. 17 is an explanatory diagram showing a second example of the operation outline regarding the verification of the D signature, and the request and acquisition of a settlement service certificate in the transaction terminal device according to Exemplary Embodiment 1;

FIG. 18 is a block diagram showing a fourth example of a functional software configuration of the transaction terminal device according to Exemplary Embodiment 1;

FIG. 19 is a flowchart for describing an example of the verification of the D signature, the request and acquisition of the settlement service certificate, and the operation procedure of the settlement process in the transaction terminal device corresponding to FIG. 18;

FIG. 20 is a block diagram showing a fifth example of a functional software configuration of the transaction terminal device according to Exemplary Embodiment 1;

FIG. 21 is a flowchart for describing an example of the verification of the D signature, the request and acquisition of the settlement service certificate, and the operation procedure of the settlement process in the transaction terminal device corresponding to FIG. 20;

FIG. 22 is a block diagram showing a sixth example of a functional software configuration of the transaction terminal device according to Exemplary Embodiment 1;

FIG. 23 is a flowchart for describing an example of the verification of the D signature, the request and acquisition of the settlement service certificate, and the operation procedure of the settlement process in the transaction terminal device corresponding to FIG. 22;

FIG. 24 is a schematic diagram showing the connection relationship between a transaction terminal device of a member store, a processor device of an acquirer or a third party and a signature generating device of a manufacturer of a transaction terminal device at the time of a settlement process;

FIG. 25 is a schematic diagram showing a first example of the connection relationship between the transaction terminal device of the member store, the processor device of the acquirer or the third party, the signature generating device of the manufacturer of the transaction terminal device, and an electronic certificate managing device of an authentication station at the time of installing a settlement application;

FIG. 26 is a schematic diagram showing a second example of the connection relationship between the transaction terminal device of the member store, the processor device of the acquirer or the third party, the signature generating device of the manufacturer of the transaction terminal device, and the electronic certificate managing device of the authentication station at the time of installing the settlement application;

FIG. 27 is an explanatory diagram showing data and the outline of a process flow at the time of installing the settlement client certificate, the D signature decryption key and the D signature-included object code of the settlement application corresponding to FIG. 25;

FIG. 28 is a flowchart for describing an operation procedure at the time of installing the settlement client certificate, the D signature decryption key and the D signature-included object code of the settlement application corresponding to FIG. 25;

FIG. 29 is an explanatory diagram showing data and the outline of a process flow at the time of installing the settlement client certificate, the D signature decryption key and the D signature-included object code of the settlement application corresponding to FIG. 26;

FIG. 30 is a flowchart for describing an operation procedure at the time of installing the settlement client certificate, the D signature decryption key and the D signature-included object code of the settlement application corresponding to FIG. 26;

FIG. 31 is an explanatory diagram showing a first example of the operation outline regarding the verification of the D signature, and the transmission of the settlement client certificate in the transaction terminal device according to Exemplary Embodiment 2;

FIG. 32 is a block diagram showing a first example of a functional software configuration of the transaction terminal device according to Exemplary Embodiment 2;

FIG. 33 is a flowchart for describing a first example of the verification of the D signature, the transmission of the settlement client certificate, and the operation procedure of the settlement process in the transaction terminal device corresponding to FIG. 32;

FIG. 34 is a block diagram showing a second example of a functional software configuration of the transaction terminal device according to Exemplary Embodiment 2;

FIG. 35 is a flowchart for describing a first example of the verification of the D signature, the transmission of the settlement client certificate, and the operation procedure of the settlement process in the transaction terminal device corresponding to FIG. 34;

FIG. 36 is a block diagram showing a third example of a functional software configuration of the transaction terminal device according to Exemplary Embodiment 2;

FIG. 37 is a flowchart for describing a first example of the verification of the D signature, the transmission of the settlement client certificate, and the operation procedure of the settlement process in the transaction terminal device corresponding to FIG. 36;

FIG. 38 is a flowchart for describing a second example of the verification of the D signature, the transmission of the settlement client certificate, and the operation procedure of the settlement process in the transaction terminal device corresponding to FIG. 33;

FIG. 39 is a flowchart for describing a second example of the verification of the D signature, the transmission of the settlement client certificate, and the operation procedure of the settlement process in the transaction terminal device corresponding to FIG. 35; and

FIG. 40 is a flowchart for describing a second example of the verification of the D signature, the transmission of the settlement client certificate, and the operation procedure of the settlement process in the transaction terminal device corresponding to FIG. 37.

### DETAILED DESCRIPTION OF THE PREFERRED EMBODIMENTS

Hereinafter, a transaction terminal device, a transaction processing method, and a transaction processing system according to an exemplary embodiment of the present invention (hereinafter, referred to as “Exemplary Embodiment”) will be described with reference to the drawings.

### Exemplary Embodiment 1

In Exemplary Embodiment 1, an example in which a settlement processing device (settlement terminal device) used in a settlement process of a transaction including the purchase of goods or the provision of services using a card (for example, a credit card) possessed by a client is used as an example of a transaction terminal device according to the present invention will be described. A settlement processing system according to Exemplary Embodiment 1 includes transaction terminal device 100 of a member store, processor device 200 of an acquirer or a third party, and signature generating device 300 of a manufacturer of the transaction terminal device.

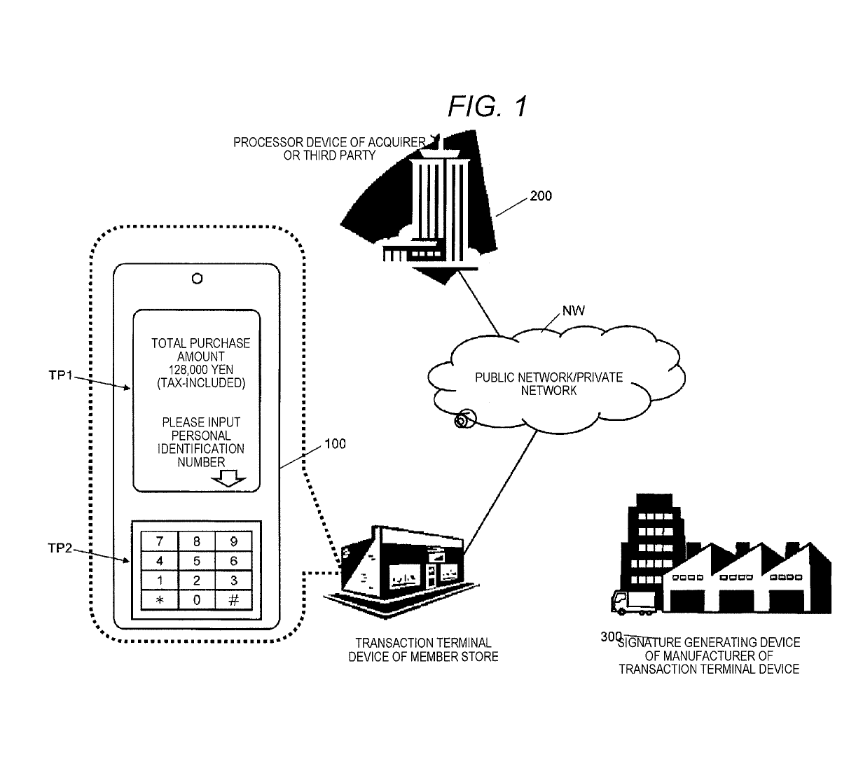

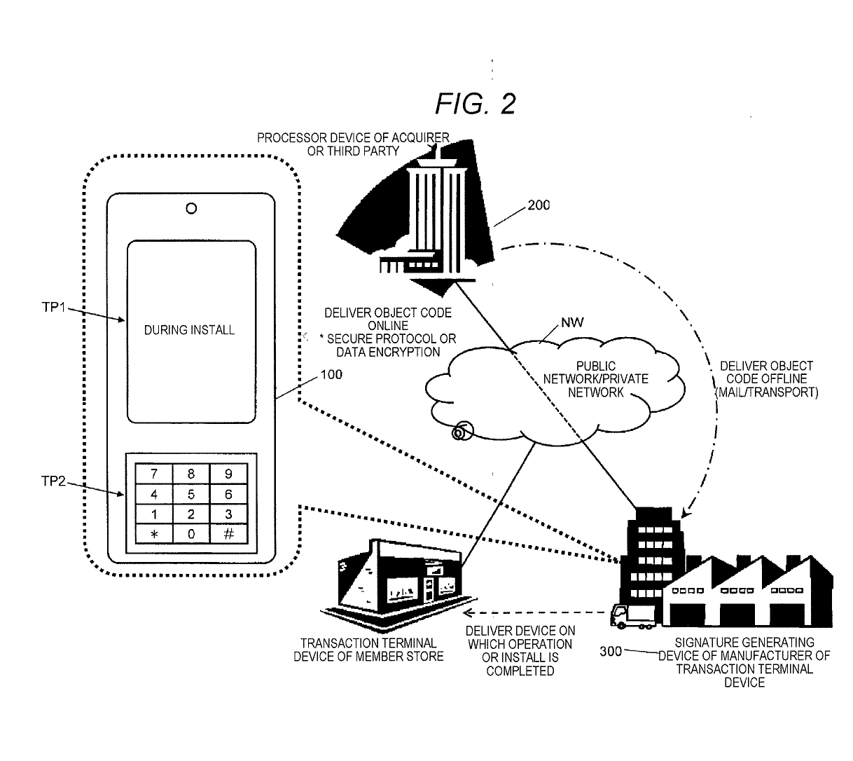

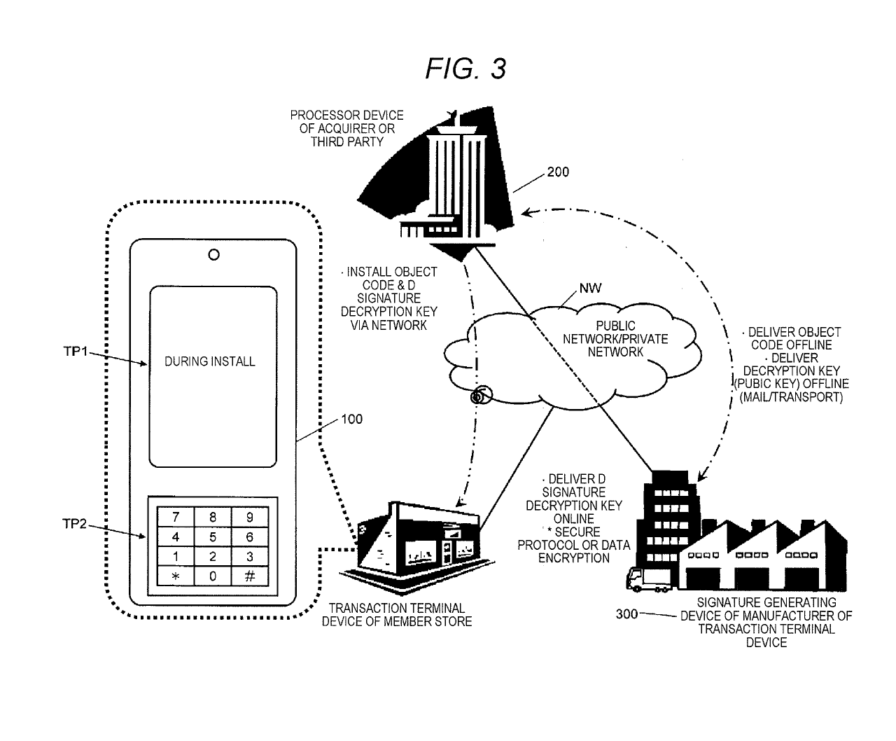

FIG. 1 is a schematic diagram showing the connection relationship between transaction terminal device 100 of the member store, processor device 200 of the acquirer or the third party and signature generating device 300 of the manufacturer of transaction terminal device 100 at the time of a settlement process. FIG. 2 is a schematic diagram showing a first example of the connection relationship between transaction terminal device 100 of the member store, processor device 200 of the acquirer or the third party and signature generating device 300 of the manufacturer of transaction terminal device 100 at the time of installing a settlement application. FIG. 3 is a schematic diagram showing a second example of the connection relationship between transaction terminal device 100 of the member store, processor device 200 of the acquirer or the third party and signature generating device 300 of the manufacturer of the transaction terminal device at the time of installing the settlement application.

Hereinafter, a transaction terminal device of a card member store (for example, a store; hereinafter, simply referred to as a “member store”) which carries out a transaction using a card is simply referred to as a “transaction terminal device”, a processor device of an acquirer or a third party is simply referred to as a “processor device”, and a signature generating device of a manufacturer of the transaction terminal device is simply referred to as a “signature generating device”. The third party includes a settlement center which carries out an agency task or a mediation task regarding a settlement process between the member store and the acquirer or between the member store and an issuer. The processor device and the signature generating device may be configured using, for example, a personal computer (PC).

Public network/private network NW shown in FIGS. 1 to 3 is a wireless network or a wired network. The wireless network is, for example, a wireless local area network (LAN), a wireless wide area network (WAN), 3G, long-term evolution (LTE), or WiGig (Wireless Gigabit). The wired network is, for example, an intranet or the Internet.

In FIG. 1, a case where a settlement process is performed between transaction terminal device 100 and processor device 200 is illustrated, and transaction terminal device 100 and processor device 200 are connected via public network/private network NW. A guide message (for example, “please, input a personal identification number”) regarding input of a personal identification number (PIN) and a purchase amount (tax included) as a target of the settlement process is displayed on first touch panel TP1 (to be described below) of transaction terminal device 100. A PIN pad (software key) for inputting the personal identification number (PIN) is displayed on second touch panel TP2 (to be described below) of transaction terminal device 100.

In FIGS. 2 and 3, in a state where a settlement application is not installed in transaction terminal device 100, the outline of a procedure of installing a settlement application and starting to use the settlement application is illustrated.

Firstly, in FIG. 2, a program code of the settlement application (hereinafter, referred to as an “object code”) is delivered from processor device 200 to signature generating device 300 offline (that is, the object code is delivered by, for example, mail or transportation without public network/private network NW; the same hereinafter). The object code may be transmitted from processor device 200 to signature generating device 300 online (that is, the object code is transmitted via public network/private network NW; the same hereinafter). In this case, processor device 200 and signature generating device 300 preferably use a secure protocol (for example, secure socket layer (SSL) or IP security protocol (IPsec)), or data encryption.

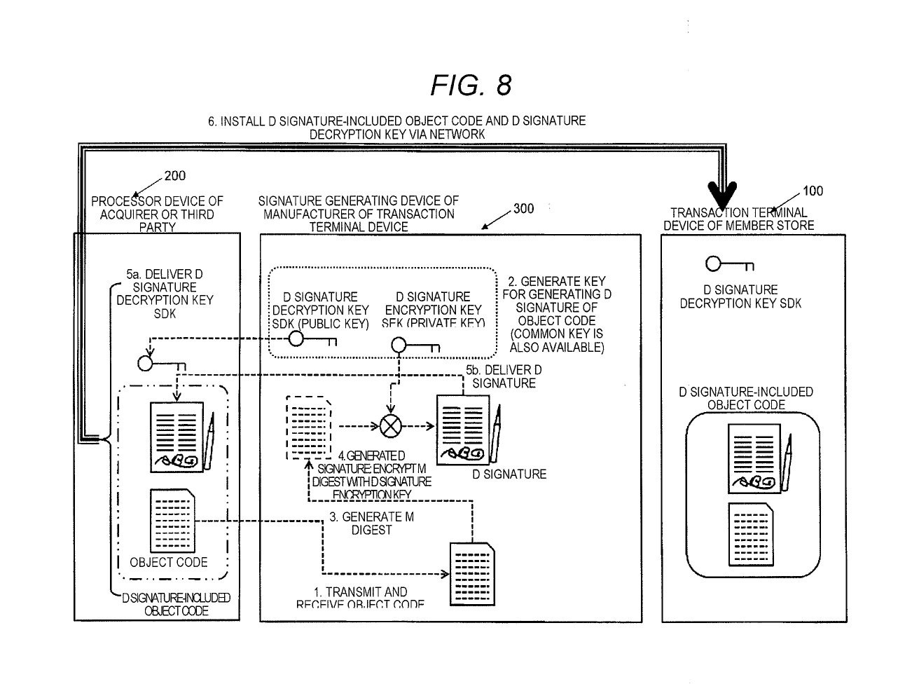

After the object code is received by signature generating device 300, the manufacturer of the transaction terminal device delivers transaction terminal device 100 in which a predetermined operation or the installing of the object code is completed to the member store offline. A person in charge of the member store receives transaction terminal device 100 delivered from the manufacturer of the transaction terminal device, provides the received transaction terminal device within the member store, and starts to use the transaction terminal device. Thus, transaction terminal device 100 can obtain the object code and D signature decryption key SDK (see FIG. 8), and can execute the settlement application.

For example, in FIGS. 2 and 3, a message (for example, “during install”) indicating that the manufacturer of the transaction terminal device is installing the settlement application is displayed on first touch panel TP1 of transaction terminal device 100. The PIN pad (software key) for inputting the personal identification number (PIN) is displayed on second touch panel TP2 (to be described below) of transaction terminal device 100.

Meanwhile, in FIG. 3, the object code is delivered from processor device 200 to signature generating device 300 offline. The object code may be transmitted from processor device 200 to signature generating device 300 online. In this case, processor device 200 and signature generating device 300 preferably use a secure protocol (for example, SSL or IPsec), or data encryption.

After the object code is received by signature generating device 300, D signature decryption key SDK used in a predetermined process (see FIG. 8) is delivered from signature generating device 300 to processor device 200 offline. Signature generating device 300 may transmit D signature decryption key SDK used in the predetermined process (see FIG. 8) to processor device 200 online. In this case, similarly, processor device 200 and signature generating device 300 preferably use a secure protocol (for example, SSL or IPsec), or data encryption.

Processor device 200 performs a process (copying process) of installing the object code and D signature decryption key SDK in transaction terminal device 100 online (network install). Thus, transaction terminal device 100 can obtain the object code and D signature decryption key SDK, and can execute the settlement application.

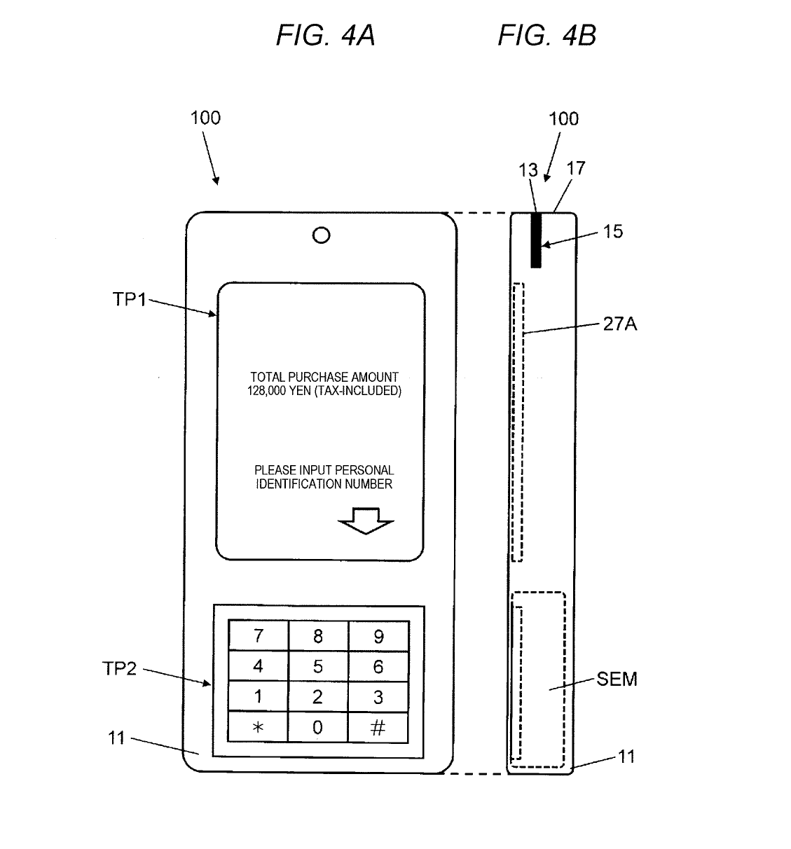

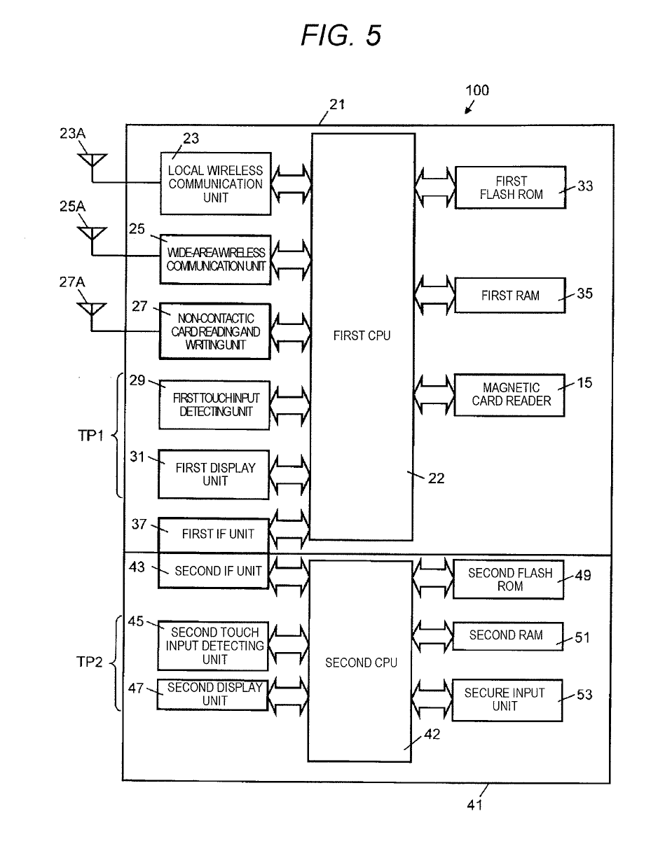

FIG. 4A is a front view of transaction terminal device 100 according to Exemplary Embodiment 1. FIG. 4B is a side view of transaction terminal device 100 shown in FIG. 4A. FIG. 5 is a block diagram showing an example of a hardware configuration of transaction terminal device 100 according to Exemplary Embodiment 1.

For example, transaction terminal device 100 according to Exemplary Embodiment 1 is a portable type, and includes non-secure first information processing unit 21, and secure second information processing unit 41 which perform various settlement processes including the settlement process in the transaction such as the purchase of goods or the provision of services (see FIG. 5). First information processing unit 21 may be secure. First information processing unit 21 does not have tamper resistance, and second information processing unit 41 has tamper resistance. Transaction terminal device 100 is configured such that first information processing unit 21 and second information processing unit 41 can be connected to each other within single housing 11.

“Secure” means that the unit has tamper resistance. “Tamper” refers to illegal analysis and modification of software or hardware within transaction terminal device 100, illegal piracy and modification of information within transaction terminal device 100, and attacks allowing the information to be disabled. Accordingly, “tamper resistance” refers to resistance to such attacks. For example, by having the tamper resistance, information related to a client is appropriately protected in the settlement process, and it is possible to safely perform a transaction.

As shown in FIG. 4A, first touch panel TP1 operated under the control of first information processing unit 21 and second touch panel TP2 operated under the control of second information processing unit 41 are provided on an operation surface (left side on a paper surface of FIG. 4B) of housing 11 of transaction terminal device 100. For example, first touch panel TP1 displays amount information as the non-secure content, and receives an input of an amount of money from a user (for example, a clerk of the member store). For example, second touch panel TP2 displays a PIN input screen (PIN pad) as the secure content, and receives an input of the PIN from a client (for example, a client who purchases goods in the member store).

First information processing unit 21 may be “secure” or may be “non-secure”. “Non-secure” means that the unit has no tamper resistance or the unit has low tamper-resistance performance.

As shown in FIG. 4A, in transaction terminal device 100, magnetic card reader 15 is disposed on a side (non-secure side) opposite to second touch panel TP2 with first touch panel TP1 interposed therebetween. Magnetic card reader 15 includes slit 13 formed on front surface 17 (in other words, an upper side on the paper surface of FIG. 4B) of first information processing unit 21. Slit 13 is a path through which a magnetic card is slid (swiped) to read information (magnetic stripe) of the magnetic card. Slit 13 may not be provided in first information processing unit 21, and may be provided in second information processing unit 41.

Transaction terminal device 100 shown in FIG. 5 includes first information processing unit 21, and second information processing unit 41. First information processing unit 21 includes first central processing unit (CPU) 22, local wireless communication unit 23, wide-area wireless communication unit 25, non-contact IC card reading and writing unit 27, first touch input detecting unit 29, first display unit 31, first flash read only memory (ROM) 33, first random access memory (RAM) 35, magnetic card reader 15, and first interface (IF) unit 37.

In first information processing unit 21, the respective units are connected to first CPU 22. First CPU 22 manages the entire first information processing unit 21, and performs, for example, controlling, processing (for example, settlement process), setting, determining, deciding and confirming in various ways.

Local wireless communication unit 23 is connected to local wireless communication antenna 23A, and has a function of performing, for example, wireless LAN communication using a local wireless communication path (not shown). Local wireless communication unit 23 may perform communication (for example, Bluetooth (registered trademark) communication) other than wireless LAN communication.

Wide-area wireless communication unit 25 is connected to wide-area wireless communication antenna 25A, and has a function of performing communication through a non-illustrated wide-area wireless communication path (for example, wide area network (WAN)). Communication in the wide-area wireless communication path may be performed using, for example, a mobile telephone network such as wideband code division multiple access (W-CDMA), universal mobile telecommunications system (UMTS), code division multiple access (CDMA) 2000, or long term evolution (LTE).

Non-contact IC card reading and writing unit 27 is connected to loop antenna 27A, and performs wireless communication with a card (for example, credit card) using predetermined short-range wireless communication (for example, near field communication (NFC)) in a non-contact manner.

First touch input detecting unit 29 has a function of detecting a touch input on first touch panel TP1. First display unit 31 has a function of controlling a display (see FIG. 4A) on first touch panel TP1. First touch input detecting unit 29 and first display unit 31 constitute first touch panel TP1.

First flash ROM 33 as an example of a storage unit has a function of storing various data. For example, the stored data may be data and a program code (object code) of the settlement application, data and program codes related to various tasks, or data and programs for controlling first information processing unit 21.

For example, when an arithmetic process according to the operation of first information processing unit 21 is performed, first RAM 35 as an example of a storage unit is a memory used for temporarily storing process data generated during the arithmetic process.

Magnetic card reader 15 is disposed inside slit 13 in FIG. 4A, and has a function of reading the magnetic stripe of the magnetic card.

First information processing unit 21 and second information processing unit 41 are connected to each other through first IF unit 37 and second IF unit 43, and various data and commands are delivered therebetween. First IF unit 37 and second IF unit 43 can be coupled to each other.

Second information processing unit 41 includes second CPU 42, second IF unit 43, second touch input detecting unit 45, second display unit 47, second flash ROM 49, second RAM 51, and secure input unit 53.

In second information processing unit 41, the respective units are connected to second CPU 42. Second CPU 42 manages the entire second information processing unit 41, and performs, for example, controlling, processing (for example, settlement process), setting, determining, deciding, confirming, authenticating, and inquiring (for example, inquiry of PIN or signature).

Second touch input detecting unit 45 has a function of detecting a touch input on second touch panel TP2. Second display unit 47 has a function of controlling a display on second touch panel TP2 (see FIG. 4A). Second touch input detecting unit 45 and second display unit 47 constitute second touch panel TP2.

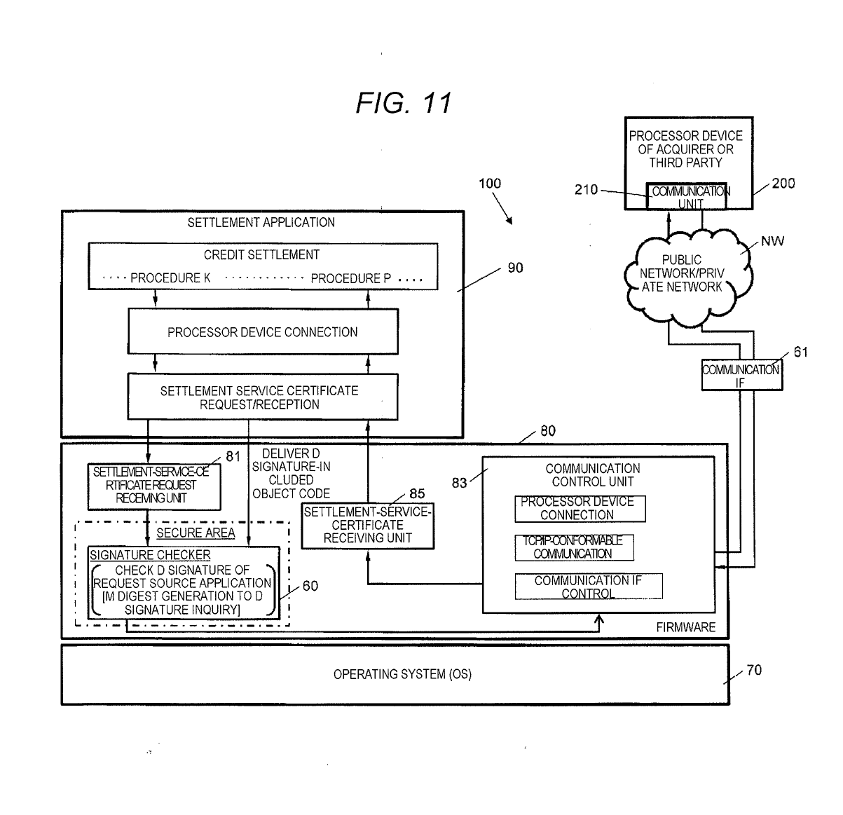

Second flash ROM 49 as an example of a storage unit has a function of storing various data. For example, the stored data may be data and programs related to various tasks and the respective units (see FIG. 11) constituting firmware 80 and operating system 70, or may be data and programs for controlling second information processing unit 41.

For example, when an arithmetic process according to the operation of second information processing unit 41 is performed, second RAM 51 as an example of a storage unit is a memory used for temporarily storing process data generated during the arithmetic process.

Secure input unit 53 may have, for example, a physical key or a software key for receiving an input of the PIN, or a software input field for receiving an input of a signature using a stylus pen or a finger of the client.

In transaction terminal device 100, “non-secure” or “secure” first information processing unit 21 and “secure” second information processing unit 41 can be coupled to each other. “Secure” second information processing unit 41 inputs and displays authentication information (for example, signature or PIN of the client) of a card used for settlement on second touch panel TP2. Accordingly, transaction terminal device 100 can securely input and display the authentication information on the card used for the settlement, and can ensure the “tamper resistance” on the input authentication information. A “secure” portion requiring the “tamper resistance” is implemented as secure module SEM localized in second information processing unit 41.

Since secure module SEM has the tamper resistance, reading of confidential data due to non-regular means is prevented. In order to increase the tamper resistance, there are a method of increasing confidentiality so as not to allow the data to be read from the outside and a method of providing a mechanism that detects whether or not the physical blockage of secure module SEM is canceled. When it is detected that the physical blockage of secure module SEM is canceled, secure module SEM may not allow the data to be read from the outside, or the program or data within secure module SEM may be destroyed. Secure module SEM may use these methods. The method that does not allow the data to be read from the outside is implemented by storing software which encodes the program, decodes the encoded program as much as necessary at the time of executing, and executes the decoded program. With regard to the reading from the outside, the method of destroying the program or data is implemented by providing a circuit which removes confidential information or safely deletes the information by rewriting the information with a predetermined value or a circuit which is not operated when the blockage of secure module SEM is canceled.

Meanwhile, as first information processing unit 21, for example, many information communication terminals (for example, smart phones and tablet terminals) distributed as devices for consumers may be used. For example, a general-purpose operating system is applied to first information processing unit 21, as a software platform.

Accordingly, development resources for the settlement application executed under the control of first information processing unit 21 and applications (hereinafter, referred to as a “task application”) used for other tasks are easily reused or applied. The settlement application and other task applications are flexibly operated without stress by being processed by first information processing unit 21 having, for example, high arithmetic processing ability.

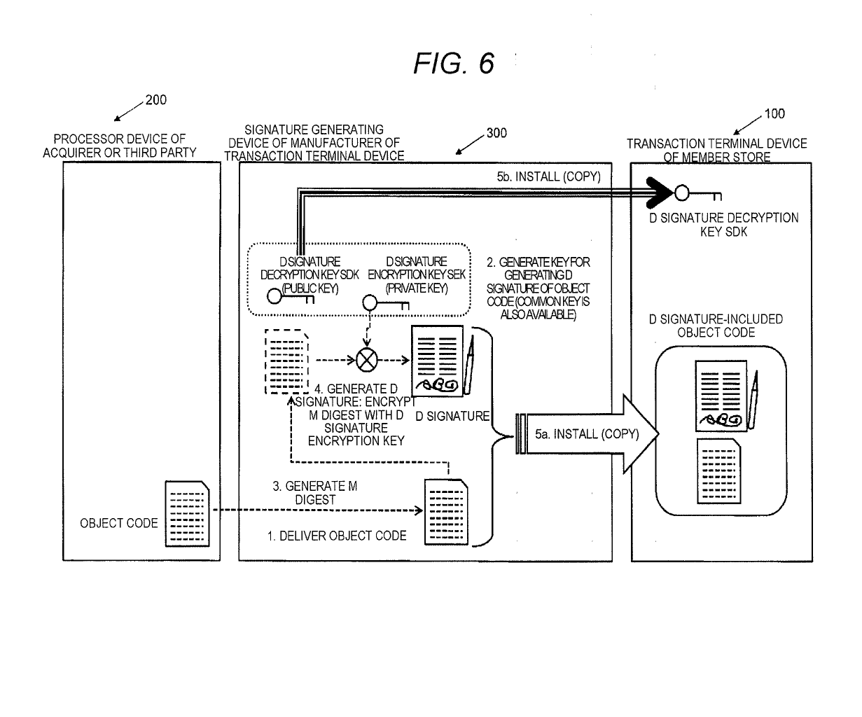

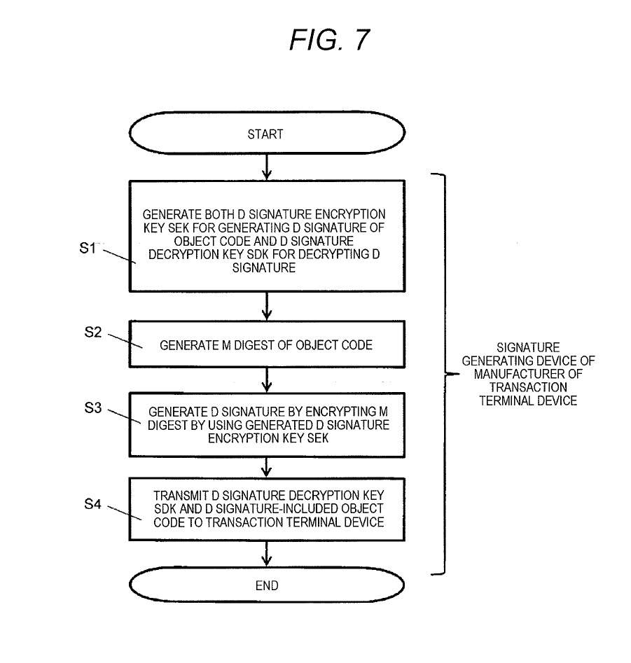

FIG. 6 is an explanatory diagram showing data and the outline of a process flow at the time of installing the settlement application corresponding to FIG. 2. FIG. 7 is a flowchart for describing an operation procedure of installing the settlement application corresponding to FIG. 2. In FIG. 7, an operation procedure of signature generating device 300 is illustrated.

As an assumption in the description of FIGS. 6 to 9, it is assumed that the program code (object code) of the settlement application is not installed in transaction terminal device 100, and the object code of the settlement application is stored in processor device 200.

As shown in FIG. 6, processor device 200 delivers or transmits the object code of the settlement application to signature generating device 300 offline or online (see FIG. 2). As described above, when the object code is transmitted online, the secure protocol (for example, SSL or IPsec) is preferably used. Needless to say, when the object code is delivered offline, the object code is delivered to the manufacturer of the transaction terminal device from the acquirer or the third party by mail or transportation. After the object code of the settlement application is obtained from processor device 200, signature generating device 300 generates both D signature encryption key SEK for generating a D signature (electronic (digital) signature; the same hereinafter.) for indicating that the object code is not illegally modified by a third person with malice and D signature decryption key SDK for decrypting the D signature (S1).

In the following description, although it will be described that the encryption key for generating the D signature and the decryption key for decrypting the D signature are a pair of a private key and a public key according to so-called public-key cryptography, the encryption key and the decryption key may be a single common key which is previously shared by signature generating device 300 and transaction terminal device 100.

Signature generating device 300 generates a conversion value (for example, a message digest (hereinafter, abbreviated to an M digest)) on a part of or all of the object code by using a predetermined hash function which is previously shared with transaction terminal device 100 (S2). Signature generating device 300 generates the D signature by encrypting the M digest generated in step S2 by using D signature encryption key SEK generated in step S1 (S3).

Signature generating device 300 delivers or transmits the D signature-included object code obtained by connecting the object code obtained in step S1 and the D signature generated in step S3 to transaction terminal device 100 offline or online (S4) (see FIG. 2). Signature generating device 300 delivers or transmits the D signature decryption key generated in step S1 to transaction terminal device 100 offline or online (S4). As described above, when the object code is transmitted online, the secure protocol (for example, SSL or IPsec) is preferably used. Needless to say, when the object code is delivered offline, the object code is delivered from the manufacturer of the transaction terminal device to the member store by mail or transportation.

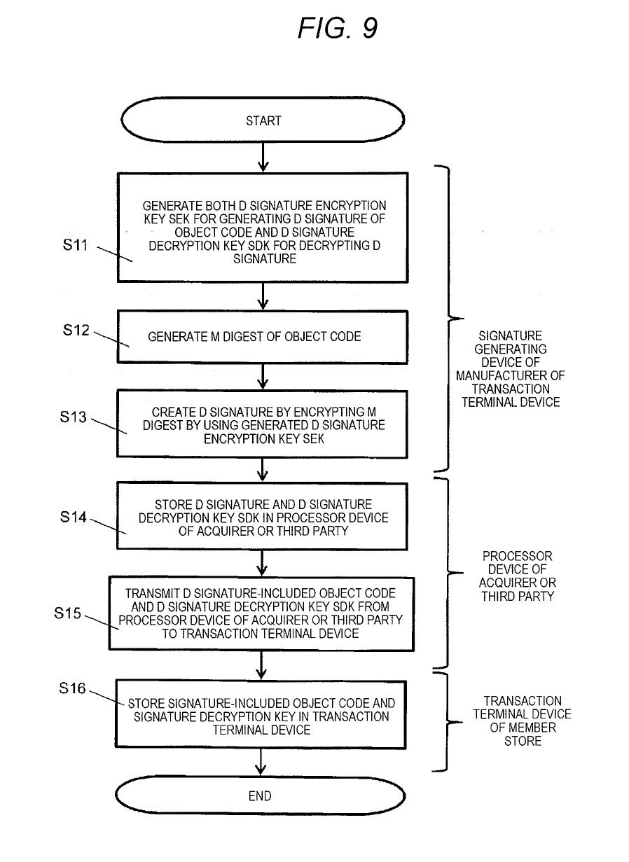

FIG. 8 is an explanatory diagram showing data and the outline of a process flow at the time of installing the settlement application corresponding to FIG. 3. FIG. 9 is a flowchart for describing an operation procedure of installing the settlement application corresponding to FIG. 3. In FIG. 9, the operation procedure of signature generating device 300, processor device 200 and transaction terminal device 100 is illustrated.

As shown in FIG. 8, processor device 200 delivers or transmits the object code of the settlement application to signature generating device 300 offline or online (see FIG. 3). As described above, when the object code is transmitted online, the secure protocol (for example, SSL or IPsec) is preferably used. Needless to say, when the object code is delivered offline, the object code is delivered to the manufacturer of the transaction terminal device from the acquirer or the third party by mail or transportation. After the object code of the settlement application is obtained from processor device 200, signature generating device 300 generates both D signature encryption key SEK for generating the D signature for indicating that the object code is not illegally modified by a third person with malice and D signature decryption key SDK for decrypting the D signature (S11).

Signature generating device 300 generates the conversion value (for example, the message digest (hereinafter, abbreviated to the M digest)) on a part of or all of the object code by using the predetermined hash function which is previously shared with transaction terminal device 100 (S12). Signature generating device 300 generates the D signature by encrypting the M digest generated in step S12 by using D signature encryption key SEK generated in step S11 (S13).

Signature generating device 300 delivers or transmits D signature decryption key SDK generated in step S11 and the D signature generated in step S13 to processor device 200 offline or online. As described above, when the object code is transmitted online, the secure protocol (for example, SSL or IPsec) is preferably used. Needless to say, when the object code is delivered offline, the object code is delivered to the acquirer or the third party from the manufacturer of the transaction terminal device by mail or transportation. Processor device 200 stores D signature decryption key SDK and the D signature (S14).

Processor device 200 transmits the D signature decryption key and the D signature-included object code obtained by connecting the D signature and the object code of the settlement application to transaction terminal device 100 online (S15) (see FIG. 3). Transaction terminal device 100 stores the D signature-included object code obtained by connecting the D signature and the object code of the settlement application, and the D signature decryption key transmitted from processor device 200 (S16).

In the description of FIGS. 6 to 9, when D signature decryption key SDK is a public key of signature generating device 300, the D signature decryption key may be stored in any of a non-secure storage area (for example, first flash ROM 33) or a secure storage area (for example, second flash ROM 49) of transaction terminal device 100. Here, when D signature decryption key SDK is a common key which is previously shared by signature generating device 300 and transaction terminal device 100, the D signature decryption key may be stored in the secure storage area (for example, second flash ROM 49) of transaction terminal device 100.

In the description of FIGS. 6 to 9, the D signature-included object code may be stored in any of the non-secure storage area (for example, first flash ROM 33) or the secure storage area (for example, second flash ROM 49) of transaction terminal device 100.

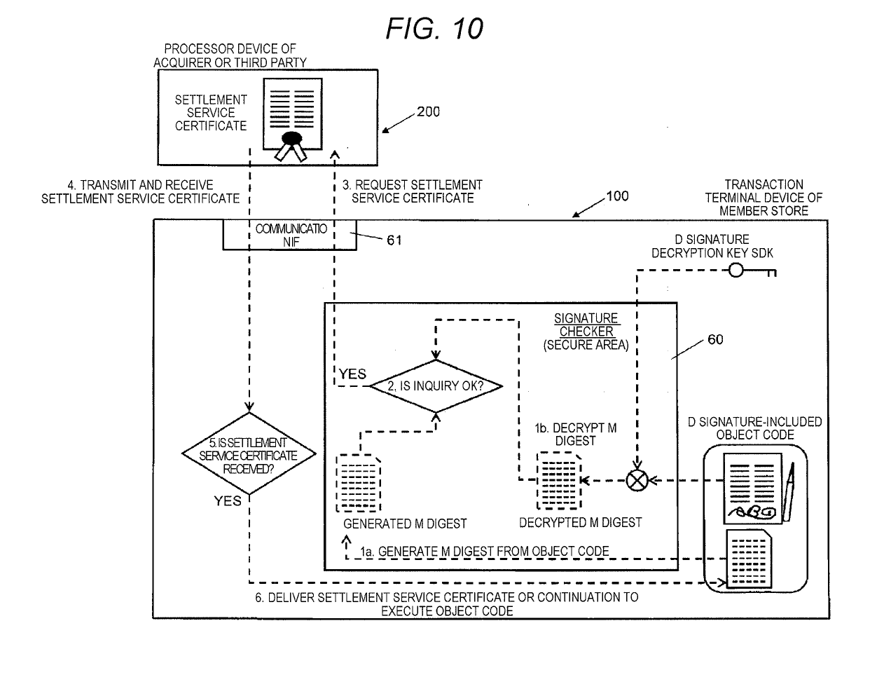

FIG. 10 is an explanatory diagram showing a first example of an operation outline regarding the verification of the D signature, and the request and acquisition of a settlement service certificate in transaction terminal device 100 according to Exemplary Embodiment 1. As an assumption in the description of FIG. 10, it is assumed that transaction terminal device 100 previously stores D signature decryption key SDK and the D signature-included object code obtained from signature generating device 300 or processor device 200 in first flash ROM 33 or second flash ROM 49, as described in FIGS. 6 to 9.

In FIG. 10, when a predetermined condition is satisfied at the time of performing communication regarding the content of the settlement process with processor device 200 of the acquirer or the third party which is a connection destination of the settlement application, transaction terminal device 100 requests the settlement service certificate for guaranteeing the reliability that processor device 200 is a regular connection destination device of the settlement application from processor device 200. The predetermined condition is a condition in which the verification of the D signature obtained from processor device 200 or signature generating device 300 succeeds, and the detailed description thereof will be described below. The verification of the D signature is performed by signature checker 60 of transaction terminal device 100.

When the verification of the D signature succeeds, transaction terminal device 100 requests the acquisition of the settlement service certificate from processor device 200. When the verification of the D signature fails, the transaction terminal device does not request the acquisition of the settlement service certificate from processor device 200. In other words, when communication regarding the content of the settlement process in the settlement application is performed, transaction terminal device 100 determines whether to connect to processor device 200 which is the connection destination of the settlement application depending on whether or not the settlement service certificate is obtained.

Specifically, in FIG. 10, transaction terminal device 100 extracts the object code from the D signature-included object code stored in first flash ROM 33 or second flash ROM 49, and generates the conversion value (for example, M digest) on a part of or all of the object code by using the predetermined hash function. Transaction terminal device 100 extracts the D signature from the D signature-included object code, and decrypts the D signature by using D signature decryption key SDK stored in first flash ROM 33 or second flash ROM 49. Transaction terminal device 100 determines whether or not the M digest obtained through decrypting coincides with the generated M digest (inquiry).

When it is determined that the M digest obtained through decrypting coincides with the generated M digest (that is, when the verification of the D signature succeeds), transaction terminal device 100 requests the acquisition of the settlement service certificate from processor device 200 between processor device 200 and the transaction terminal device through communication IF 61. Processor device 200 transmits the settlement service certificate in response to the request from transaction terminal device 100. Transaction terminal device 100 receives the settlement service certificate through communication IF 61. After the settlement service certificate is received, transaction terminal device 100 stores the received settlement service certificate in first flash ROM 33 or second flash ROM 49, or continues to perform the settlement process in the settlement application by using the settlement service certificate. Here, communication IF 61 is at least one of wide-area wireless communication unit 25 and local wireless communication unit 23.

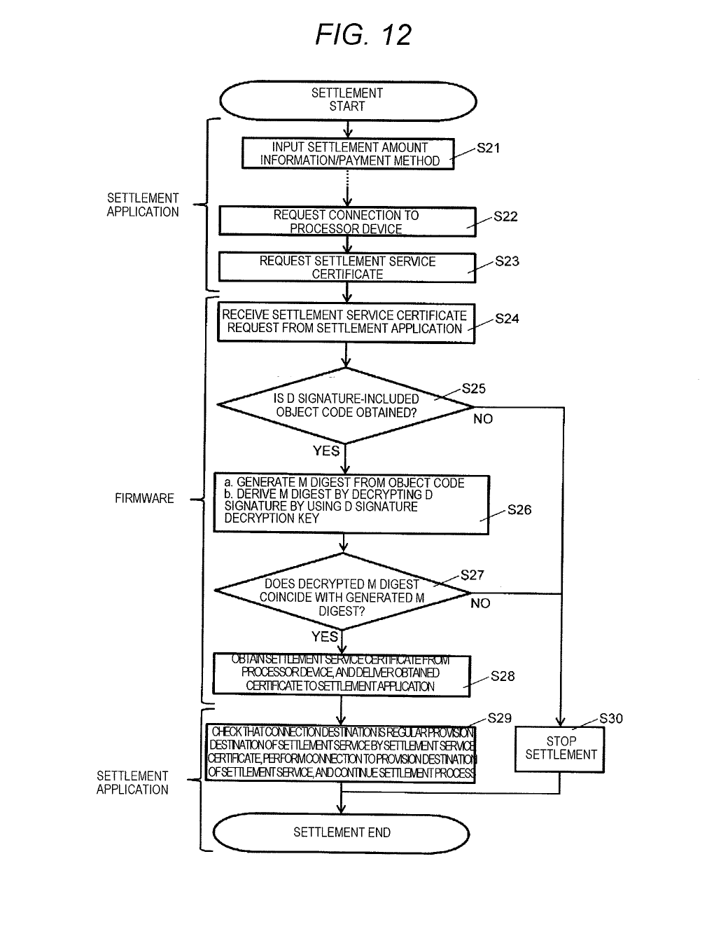

FIG. 11 is a block diagram showing a first example of a functional software configuration of transaction terminal device 100 according to Exemplary Embodiment 1. FIG. 12 is a flowchart for describing an example of the verification of the D signature, the request and acquisition of the settlement service certificate, and the operation procedure of the settlement process in transaction terminal device 100 corresponding to FIG. 11.

Transaction terminal device 100 shown in FIG. 11 includes at least communication IF 61, operating system (OS) 70, firmware 80 operated under operating system 70, and settlement application 90 operated under firmware 80. Firmware 80 includes signature checker 60, settlement-service-certificate request receiving unit 81, communication control unit 83, and settlement-service-certificate receiving unit 85.

For example, communication IF 61 is configured using a circuit conformable to a predetermined communication scheme used by transaction terminal device 100, and mediates a communication process between communication control unit 83 and public network/private network NW.

Operating system 70 is basic software that controls a basic operation of transaction terminal device 100.

Settlement-service-certificate request receiving unit 81 receives the request for the acquisition of the settlement service certificate from settlement application 90, and sends the received request to signature checker 60.

Signature checker 60 as an example of a signature verifying unit is stored in the secure storage area (for example, second flash ROM 49) of transaction terminal device 100, receives the D signature-included object code from settlement application 90, and checks (verifies) the D signature of the D signature-included object code in response to the instruction from a request source application (for example, settlement application 90) which requests the acquisition of the settlement service certificate. Specifically, as described with reference to FIG. 10, signature checker 60 generates the M digest for the object code, decrypts the D signature using D signature decryption key SDK, and compares whether or not the M digest obtained through decrypting coincides with the generated M digest. When the verification of the D signature succeeds, signature checker 60 transmits the request for the acquisition of the settlement service certificate to communication control unit 83.

Communication control unit 83 performs communication connection to processor device 200 via public network/private network NW, communication control conformable to TCP/IP, and control of communication IF 61, and transmits the request for the acquisition of the settlement service certificate transmitted from signature checker 60 to processor device 200 through communication IF 61 and public network/private network NW. Communication control unit 83 receives the settlement service certificate transmitted from communication unit 210 of processor device 200, and transmits the received certificate to settlement-service-certificate receiving unit 85.

Settlement-service-certificate receiving unit 85 receives the settlement service certificate transmitted from communication control unit 83, and transmits the settlement service certificate to settlement application 90.

Settlement application 90 as an example of a settlement processing unit is an application which performs the settlement process of the transaction using the card (for example, credit card) possessed by the client. As described with reference to FIGS. 6 to 9, the settlement application can be executed while being delivered or transmitted from signature generating device 300 or processor device 200 and being installed.

For example, during a plurality of procedures (for example, procedure K, . . . , and procedure P) in the settlement (credit settlement) of the transaction using the credit card, settlement application 90 receives an input of settlement amount information or a payment method of the transaction, receives an input of the authentication information (for example, PIN) of the client, or requests the connection to processor device 200. In FIG. 11, for example, settlement application 90 outputs the request for the acquisition of the settlement service certificate to settlement-service-certificate request receiving unit 81 at the time of requesting the connection to processor device 200.

Settlement application 90 starts communication (for example, credit inquiry) regarding the content of the settlement process with processor device 200 as a settlement center by using the settlement service certificate transmitted from settlement-service-certificate receiving unit 85.

Processor device 200 includes, for example, at least communication unit 210, and a storage unit (not shown) that retains the settlement service certificate. When the request for the acquisition of the settlement service certificate is received from transaction terminal device 100, communication unit 210 obtains the settlement service certificate from a non-illustrated storage unit, and transmits (replies) the obtained certificate to transaction terminal device 100.

In FIG. 12, transaction terminal device 100 executes settlement application 90 installed in, for example, first information processing unit 21, and starts the settlement process. Settlement application 90 receives an input of various information items (for example, settlement amount information, payment method, and card brand information used for settlement) regarding the settlement (S21).

After step S21, when the settlement application requests connection to processor device 200 as a settlement center (S22), settlement application 90 generates the request for the acquisition of the settlement service certificate, and outputs the generated certificate to settlement-service-certificate request receiving unit 81 (S23).

Settlement-service-certificate request receiving unit 81 receives the request for the acquisition of the settlement service certificate from settlement application 90, and transmits the received request to signature checker 60 (S24). When the D signature-included object code is obtained from settlement application 90 (S25, YES), signature checker 60 extracts the object code from the D signature-included object code, and generates the M digest by using the predetermined hash function. Further, the signature checker decrypts the D signature by using D signature decryption key SDK of settlement application 90, and derives the M digest (S26).

When it is determined that the generated M digest coincides with the M digest obtained through decrypting (S27, YES), signature checker 60 transmits the request for the acquisition of the settlement service certificate to communication control unit 83. Communication control unit 83 transmits the request for the acquisition of the settlement service certificate transmitted from signature checker 60 to processor device 200 through communication IF 61 and public network/private network NW. Communication control unit 83 receives the settlement service certificate transmitted from communication unit 210 of processor device 200, and transmits the received certificate to settlement-service-certificate receiving unit 85. Settlement-service-certificate receiving unit 85 receives the settlement service certificate transmitted from communication control unit 83, and transmits the settlement service certificate to settlement application 90 (S28).

Since it can be checked that the processor device as the connection destination device of the settlement application is a regular provision destination of the settlement service by the settlement service certificate, settlement application 90 performs connection for communication with processor device 200 which is the provision destination of the settlement service and continues to perform the settlement process performed after step S22 (S29).

Meanwhile, when signature checker 60 does not obtain the D signature-included object code from settlement application 90 (S25, NO) or fails to verify the D signature (that is, when the M digest generated in step S26 does not coincide with the M digest obtained through decrypting) (S27, NO), signature checker 60 omits the request for the acquisition of the settlement service certificate, and outputs the instruction that the settlement process in settlement application 90 stops to settlement application 90 (S30). Thus, settlement application 90 stops performing the content of the settlement process after step S22.

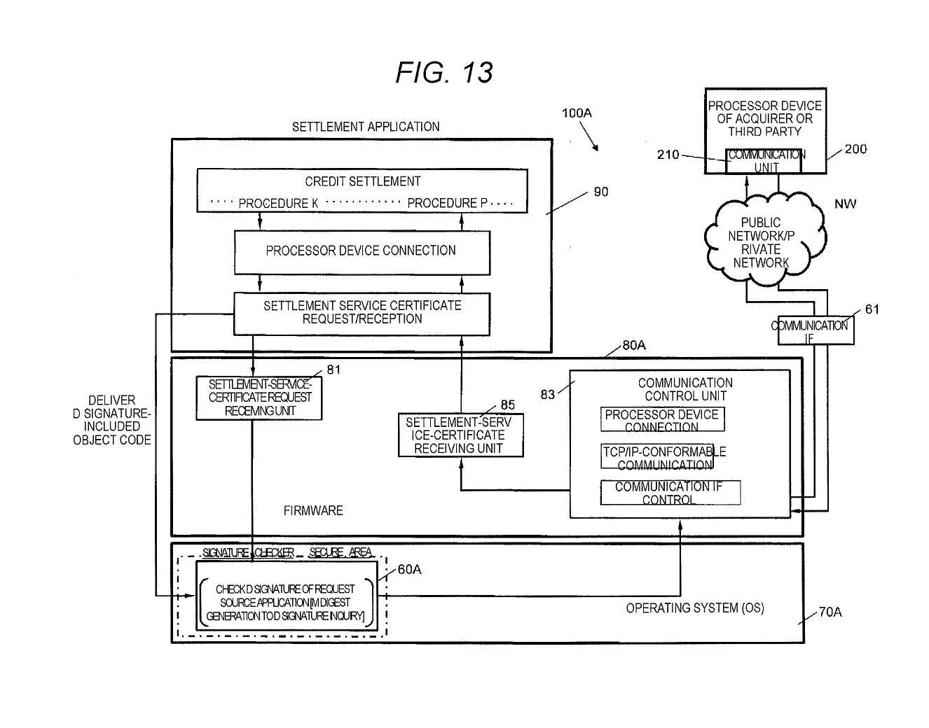

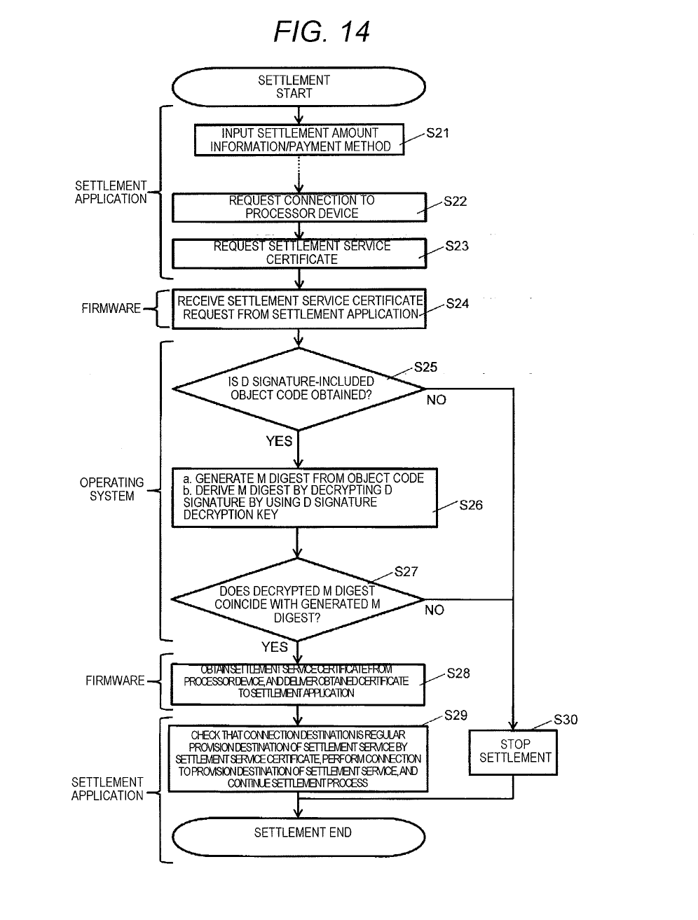

FIG. 13 is a block diagram showing a second example of a functional software configuration of transaction terminal device 100A according to Exemplary Embodiment 1. FIG. 14 is a flowchart for describing an example of the verification of the D signature, the request and acquisition of the settlement service certificate, and the operation procedure of the settlement process in transaction terminal device 100A corresponding to FIG. 13. In the description of FIGS. 13 and 14, the content different from the content of FIGS. 11 and 12 corresponding thereto will be described, and the description of the same content will be simplified or omitted.

In FIG. 13, signature checker 60A as an example of a signature verifying unit is provided not in firmware 80A but in operating system 70A, and another configuration is the same as that of FIG. 11. In FIG. 14, processes are the same as those of the flowchart shown in FIG. 12 except for the fact that processes from step S25 to step S27 are performed by operating system 70A and step S24 and step S28 are performed by firmware 80A, and thus, the description thereof will be omitted.

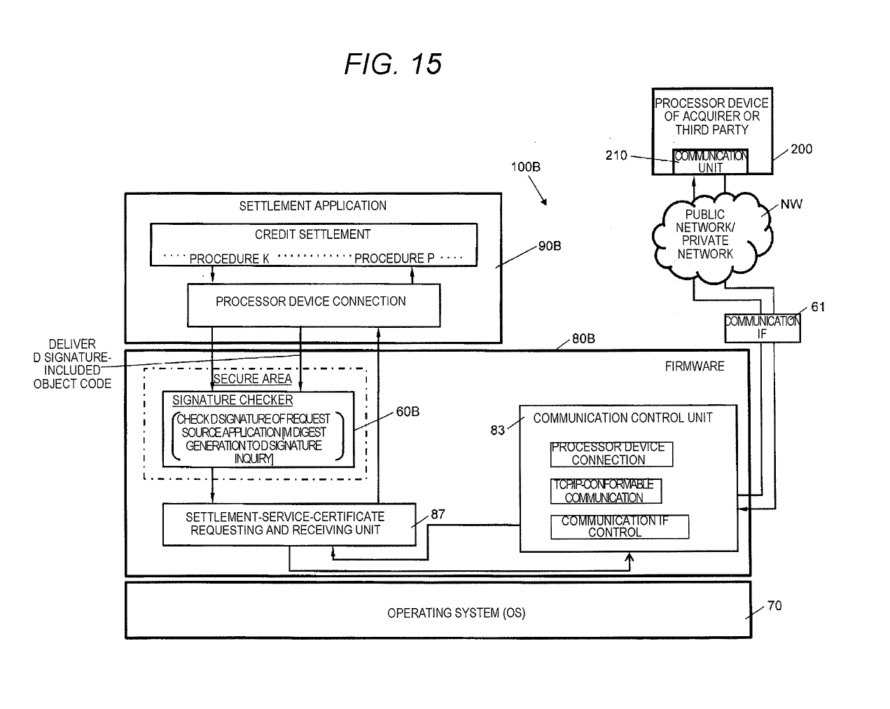

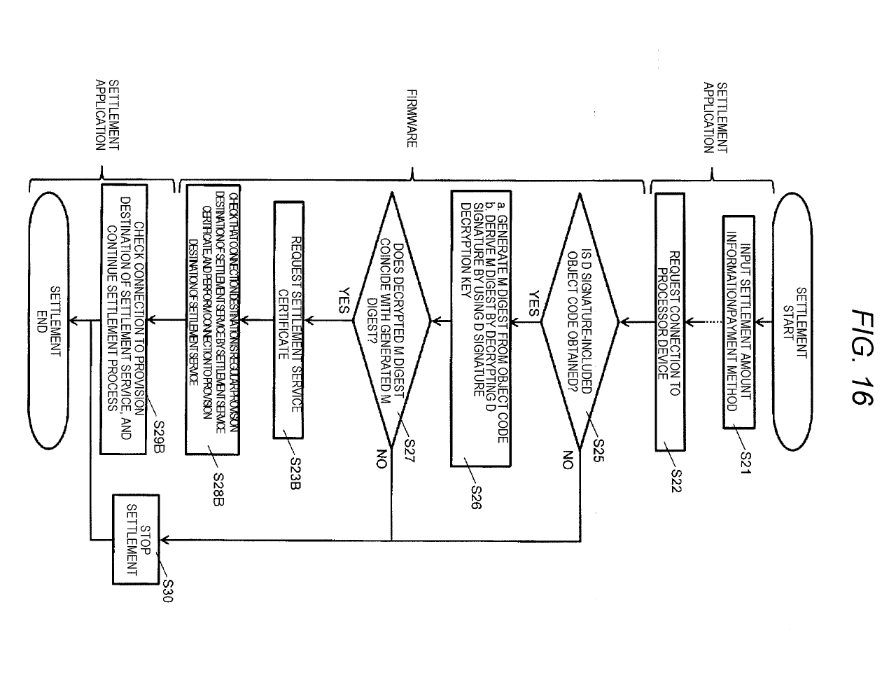

FIG. 15 is a block diagram showing a third example of a functional software configuration of transaction terminal device 100B according to Exemplary Embodiment 1. FIG. 16 is a flowchart for describing an example of the verification of the D signature, the request and acquisition of the settlement service certificate, and the operation procedure of the settlement process in transaction terminal device 100B corresponding to FIG. 15. In the description of FIGS. 15 and 16, the content different from the content of FIGS. 11 and 12 corresponding thereto will be described, and the description of the same content will be simplified or omitted.

In FIG. 15, although signature checker 60B as an example of a signature verifying unit is provided in firmware 80B, settlement-service-certificate requesting and receiving unit 87 is provided in place of settlement-service-certificate request receiving unit 81 and settlement-service-certificate receiving unit 85 shown in FIG. 11. That is, although the request for the acquisition of the settlement service certificate is transmitted from settlement application 90 in FIG. 11, the request for the acquisition of the settlement service certificate is transmitted from settlement-service-certificate requesting and receiving unit 87 of firmware 80B in FIG. 15.

Signature checker 60B receives the D signature-included object code from settlement application 90B, and checks (verifies) the D signature in response to the instruction from the request source application (for example, settlement application 90B) which requests communication connection to processor device 200 as a settlement center. A method of checking (verifying) the D signature is the same, and thus, the description thereof will be omitted.

When the verification of the D signature in signature checker 60B succeeds, settlement-service-certificate requesting and receiving unit 87 generates the request for the acquisition of the settlement service certificate, and transmits the generated certificate to communication control unit 83. Settlement-service-certificate requesting and receiving unit 87 receives the settlement service certificate transmitted from processor device 200 from communication control unit 83, and transmits the received certificate to settlement application 90B.

In FIG. 16, after settlement application 90B requests communication connection from processor device 200 as a settlement center during the settlement process in step S22, when the D signature-included object code is obtained from settlement application 90B (S25, YES), signature checker 60B extracts the object code from the D signature-included object code, and generates the M digest by using the predetermined hash function. Further, the signature checker decrypts the D signature by using D signature decryption key SDK of settlement application 90B, and derives the M digest (S26).

When it is determined that the generated M digest coincides with the M digest obtained through decrypting (S27, YES), signature checker 60B instructs settlement-service-certificate requesting and receiving unit 87 to generate the request for the acquisition of the settlement service certificate (S23B). Thus, settlement-service-certificate requesting and receiving unit 87 generates the request for the acquisition of the settlement service certificate, and transmits the generated request to communication control unit 83. Settlement-service-certificate requesting and receiving unit 87 receives the settlement service certificate which is transmitted from processor device 200 from communication control unit 83, checks that the connection destination is a regular provision destination of the settlement service by the settlement service certificate, and is then connected to the provision destination of the settlement service (S28B). After firmware 80B checks the connection to processor device 200 which is the provision destination of the settlement service, settlement application 90B continues to perform the settlement process performed after step S22 (S29B).

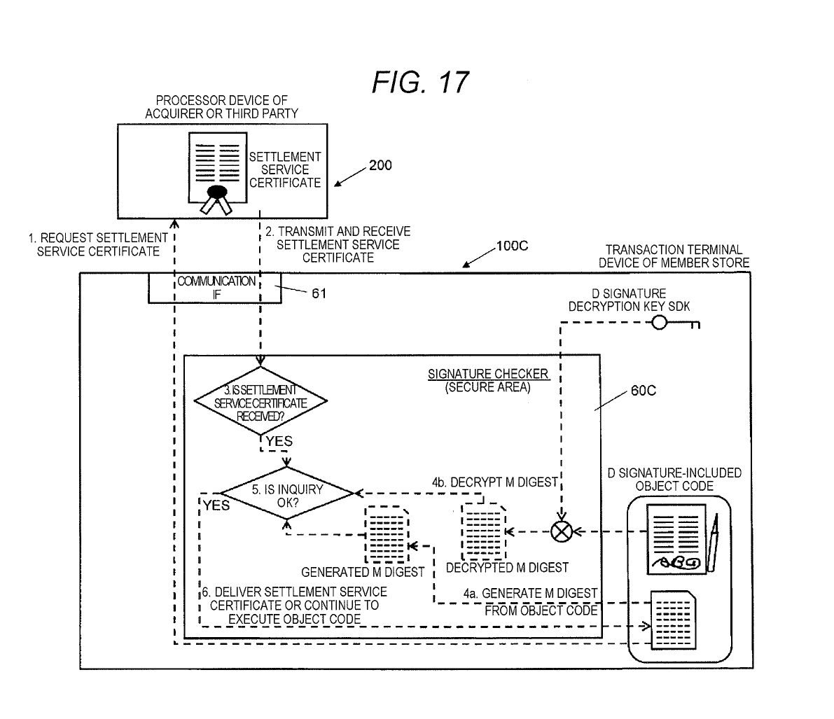

FIG. 17 is an explanatory diagram showing a second example of the operation outline regarding the verification of the D signature, and the request and acquisition of a settlement service certificate in transaction terminal device 100C according to Exemplary Embodiment 1. As an assumption in the description of FIG. 17, it is assumed that transaction terminal device 100C previously stores D signature decryption key SDK and the D signature-included object code obtained from signature generating device 300 or processor device 200 in first flash ROM 33 or second flash ROM 49, as described in FIGS. 6 to 9.

In FIG. 17, transaction terminal device 100C requests the settlement service certificate for guaranteeing the reliability that processor device 200 is a regular connection destination device of the settlement application from processor device 200, and obtains the settlement service certificate. Thereafter, when a predetermined condition is satisfied, transaction terminal device performs communication regarding the content of the settlement process with processor device 200 of the acquirer or the third party which is the connection destination of settlement application 90 by using the settlement service certificate. As described with reference to FIG. 10, the predetermined condition is a condition in which the verification of the D signature obtained from processor device 200 or signature generating device 300 succeeds. The verification of the D signature is performed by signature checker 60C of transaction terminal device 100C.

Since the request for the acquisition of the settlement service certificate is transmitted to processor device 200 before the verification of the D signature is performed, transaction terminal device 100C obtains the settlement service certificate before the verification of the D signature is performed. In other words, although the settlement service certificate is obtained before the verification of the D signature is performed, transaction terminal device 100C determines whether or not to perform the communication connection regarding the content of the settlement process in the settlement application using the settlement service certificate depending on whether or not verification of the D signature succeeds.

Specifically, in FIG. 17, transaction terminal device 100C requests the acquisition of the settlement service certificate from processor device 200 between processor device 200 and transaction terminal device through communication IF 61. Processor device 200 transmits the settlement service certificate in response to the request from transaction terminal device 100C. Transaction terminal device 100C receives the settlement service certificate through communication IF 61. Here, communication IF 61 is at least one of wide-area wireless communication unit 25 and local wireless communication unit 23.

After the settlement service certificate is obtained, transaction terminal device 100C extracts the object code from the D signature-included object code stored in first flash ROM 33 or second flash ROM 49, and generates a conversion value (for example, M digest) on a part of or all of the object code by using the predetermined hash function. Transaction terminal device 100C extracts the D signature from the D signature-included object code, and decrypts the D signature by using D signature decryption key SDK stored in first flash ROM 33 or second flash ROM 49. Transaction terminal device 100C determines whether or not the M digest obtained through decrypting coincides with the generated M digest (inquiry).

When it is determined that the M digest obtained through decrypting coincides with the generated M digest (that is, when the verification of the D signature succeeds), transaction terminal device 100C stores the received settlement service certificate in first flash ROM 33 or second flash ROM 49, or continues to perform the settlement process in the settlement application by using the settlement service certificate.

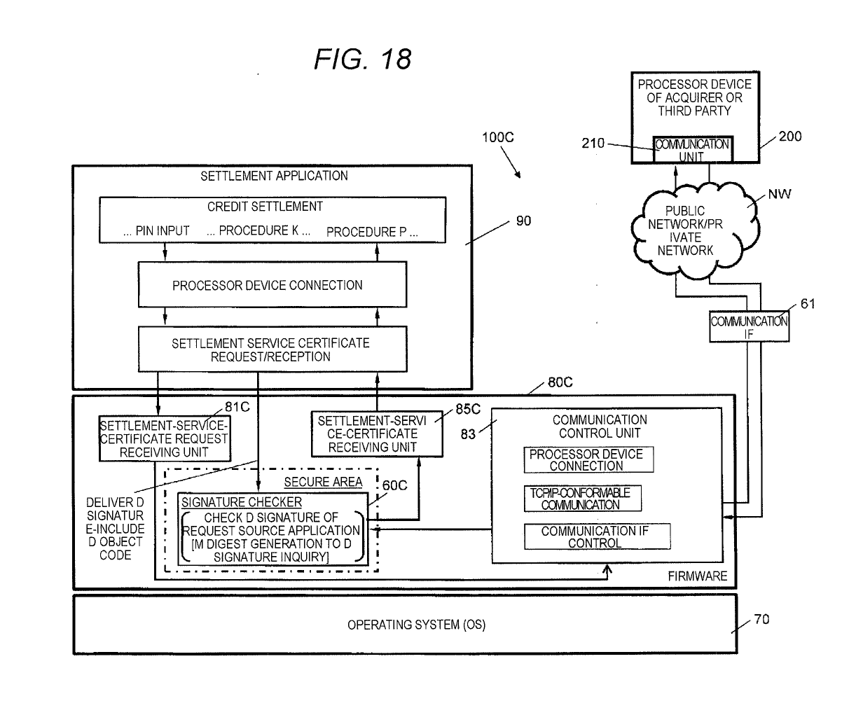

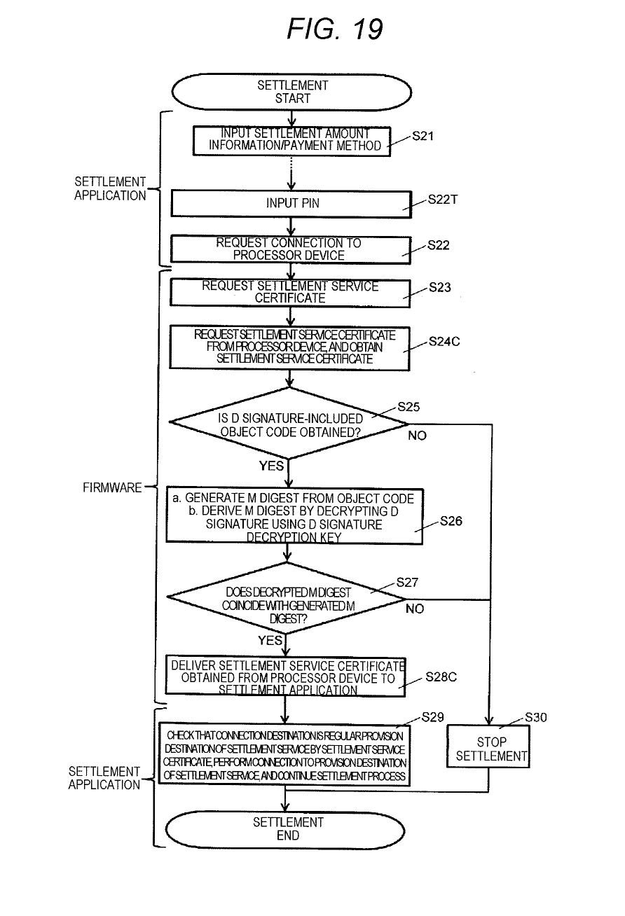

FIG. 18 is a block diagram showing a fourth example of a functional software configuration of transaction terminal device 100C according to Exemplary Embodiment 1. FIG. 19 is a flowchart for describing an example of the verification of the D signature, the request and acquisition of the settlement service certificate, and the operation procedure of the settlement process in transaction terminal device 100C corresponding to FIG. 18. In the description of FIGS. 18 and 19, the content different from the content of FIGS. 11 and 12 corresponding thereto will be described, and the description of the same content will be simplified or omitted.

In FIG. 18, settlement-service-certificate request receiving unit 81C receives the request for the acquisition of the settlement service certificate from settlement application 90, and transmits the received certificate to communication control unit 83.

Signature checker 60C as an example of a signature verifying unit receives the D signature-included object code from settlement application 90, and checks (verifies) the D signature of the D signature-included object code by receiving the settlement service certificate transmitted from communication control unit 83. The D signature is checked (verified) similarly to signature checker 60 shown in FIG. 13, and thus, the description thereof will be omitted. When the verification of the D signature succeeds, signature checker 60C transmits the settlement service certificate to settlement-service-certificate receiving unit 85.

Settlement-service-certificate receiving unit 85C receives the settlement service certificate transmitted from signature checker 60C, and transmits the settlement service certificate to settlement application 90.

In FIG. 19, after step S21, at a point of time (S22T) when an input of an authentication number of the client (for example, personal identification number: PIN) is performed, settlement application 90 requests connection to processor device 200 as a settlement center (S22), generates the request for the acquisition of the settlement service certificate, and outputs the generated certificate to settlement-service-certificate request receiving unit 81C (S23).

Settlement-service-certificate request receiving unit 81C receives the request for the acquisition of the settlement service certificate from settlement application 90, and transmits the received request to communication control unit 83 (S24C). Communication control unit 83 receives the request for the acquisition of the settlement service certificate from settlement-service-certificate request receiving unit 81C, and transmits the received request to processor device 200 through communication IF 61 and public network/private network NW. Communication control unit 83 receives the settlement service certificate transmitted from communication unit 210 of processor device 200, and transmits the received certificate to signature checker 60C (S24C).

The processes of signature checker 60C after step S24C are the same as the processes from step S25 to step S27 shown in FIG. 12, and when the verification of the D signature succeeds (S27, YES), signature checker 60C transmits the request for the acquisition of the settlement service certificate to settlement-service-certificate receiving unit 85C. Settlement-service-certificate receiving unit 85C receives the settlement service certificate transmitted from signature checker 60C, and transmits the settlement service certificate to settlement application 90 (S28C). The processes after step S28C are the same as the processes after step S28 shown in FIG. 12, and thus, the description thereof will be omitted.

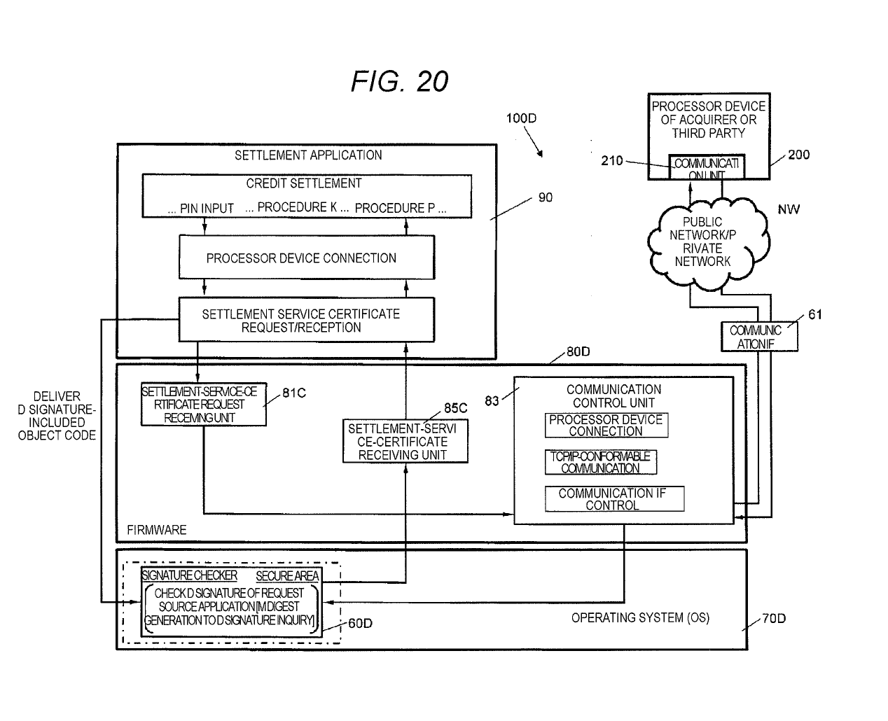

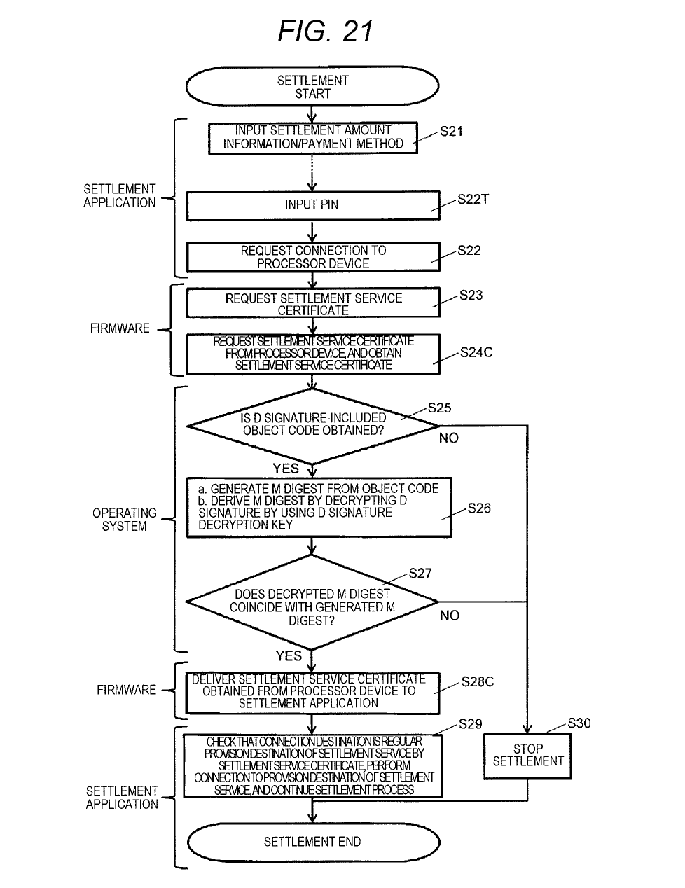

FIG. 20 is a block diagram showing a fifth example of a functional software configuration of transaction terminal device 100D according to Exemplary Embodiment 1. FIG. 21 is a flowchart for describing an example of the verification of the D signature, the request and acquisition of the settlement service certificate, and the operation procedure of the settlement process in transaction terminal device 100D corresponding to FIG. 20. In the description of FIGS. 20 and 21, the content different from the content of FIGS. 18 and 19 corresponding thereto will be described, and the description of the same content will be simplified or omitted.

In FIG. 20, signature checker 60D as an example of a signature verifying unit is provided not in firmware 80D but in operating system 70D, and another configuration is the same as that of FIG. 18. In FIG. 21, processes are the same as those of the flowchart shown in FIG. 19 except for the fact that processes from step S25 to step S27 are performed by operating system 70D and step S24C and S28C are performed by firmware 80D, and thus, the description thereof will be omitted.

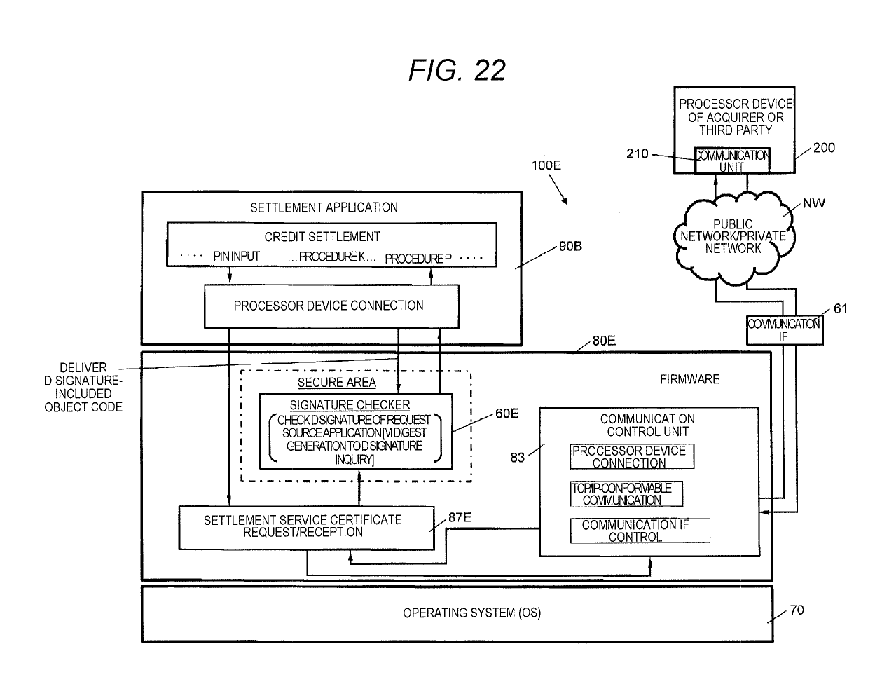

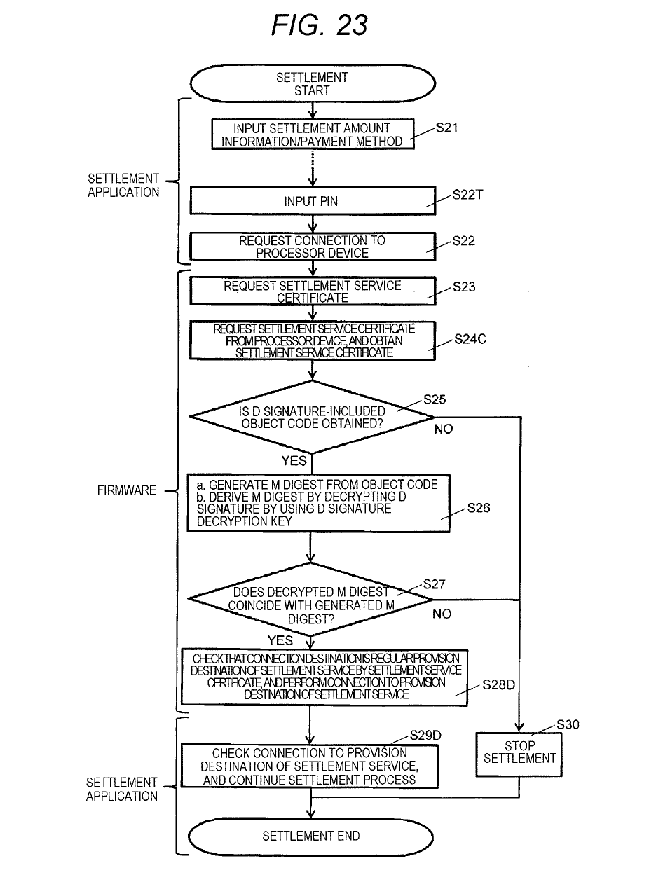

FIG. 22 is a block diagram showing a sixth example of a functional software configuration of transaction terminal device 100E according to Exemplary Embodiment 1. FIG. 23 is a flowchart for describing an example of the verification of the D signature, the request and acquisition of the settlement service certificate, and the operation procedure of the settlement process in transaction terminal device 100E corresponding to FIG. 22. In the description of FIGS. 22 and 23, the content different from the content of FIGS. 18 and 19 corresponding thereto will be described, and the description of the same content will be simplified or omitted.

In FIG. 22, although signature checker 60E as an example of a signature verifying unit is provided in firmware 80E, settlement-service-certificate requesting and receiving unit 87E is provided in place of settlement-service-certificate request receiving unit 81C and settlement-service-certificate receiving unit 85C shown in FIG. 18. That is, although the request for the acquisition of the settlement service certificate is transmitted from settlement application 90 in FIG. 18, the request for the acquisition of the settlement service certificate is transmitted from settlement-service-certificate requesting and receiving unit 87E of firmware 80E in FIG. 22. FIG. 23 is different from FIG. 19 in that the processes before step S22T are performed by settlement application 90B and the processes after the subsequent step S23 are performed by firmware 80E. Firmware 80E checks that a connection destination is a regular provision destination of the settlement service by using settlement service certificate in step S28D, and performs connection to the provision destination of the settlement service. After firmware 80E checks connection to processor device 200 which is the provision destination of the settlement service, settlement application 90B continues to perform the settlement process performed after step S22T (S29D). The entire process flow is the same as that of FIG. 19, and thus, the description thereof will be omitted.

As described above, transaction terminal devices 100 and 100A to 100E according to Exemplary Embodiment 1 request the settlement service certificate for guaranteeing the regularity of processor device 200 which is the connection destination device (settlement destination device) in the settlement process from processor device 200, stores the D signature obtained by encrypting at least the partial program code of settlement application 90 or 90B by using predetermined D signature encryption key SEK and predetermined D signature decryption key SDK corresponding to predetermined D signature encryption key SEK in first flash ROM 33 or second flash ROM 49, and verifies whether or not the conversion value (for example, the M digest generated using the predetermined hash function) on the partial program code of settlement application 90 or 90B coincides with the decrypted output value (for example, the M digest obtained through decrypting) obtained by decrypting the D signature by using D signature decryption key SDK. Processor device 200 transmits the settlement service certificate to transaction terminal devices 100 and 100A to 100E in response to the request from transaction terminal devices 100 and 100A to 100E.

Thus, transaction terminal devices 100 and 100A to 100E can appropriately determine whether or not the settlement service certificate indicating that processor device 200 is the regular provision destination of the settlement service in the settlement process is obtained depending on the verified result (that is, the verified result of whether or not the conversion value on the partial program code of settlement application 90 coincides with the decrypted output value obtained by decrypting the D signature by using D signature decryption key SDK) of the regularity of the D signature assigned to the partial program code of settlement application 90 or 90B. Transaction terminal devices 100 and 100A to 100E can appropriately determine whether or not to connect to processor device 200 depending on whether or not the settlement service certificate obtained from processor device 200 is present.

When the conversion value and the decrypted output value coincide with each other (that is, neither the partial program code of settlement application 90 or 90B nor D signature decryption key SDK are modified), transaction terminal devices 100 and 100A to 100E request the settlement service certificate from processor device 200. Thus, when the settlement service certificate is transmitted from processor device 200, transaction terminal devices 100 and 100A to 100E can safely perform the settlement process between transaction terminal device and processor device 200 by using the obtained settlement service certificate.

Before the verification (that is, verification of whether or not the conversion value on the partial program code of settlement application 90 or 90B coincides with the decrypted output value obtained by decrypting the D signature by using D signature decryption key SDK) of the D signature is performed, transaction terminal devices 100 and 100A to 100E request the settlement service certificate from processor device 200. Thus, even though transaction terminal devices 100 and 100A to 100E obtain the settlement service certificate before the D signature is verified, since settlement application 90 or 90B does not obtain the settlement service certificate until it is determined that the verified result of the D signature is legal (that is, the conversion value on the partial program code of settlement application 90 or 90B coincides with the decrypted output value obtained by decrypting the D signature by using D signature decryption key SDK) and settlement application 90 or 90B obtains the settlement service certificate for the first time after it is determined that the verified result of the D signature is legal, transaction terminal devices 100 and 100A to 100E can safely perform the settlement process between processor device 200 and the transaction terminal device by using the settlement service certificate.

Before the communication with processor device 200 starts in the settlement process between processor device 200 and the transaction terminal device, transaction terminal devices 100 and 100A to 100E instruct that the settlement service certificate is requested. Thus, after the settlement service certificate indicating that processor device 200 is the regular provision destination of the settlement service in the settlement process is obtained, transaction terminal devices 100 and 100A to 100E can safely perform communication with processor device 200.

When an input of the authentication information (for example, the personal identification number such as PIN) regarding the client in the settlement process between the transaction terminal device and processor device 200 is received, transaction terminal devices 100 and 100A to 100E instruct that the settlement service certificate is requested. Thus, since the settlement service certificate can be obtained before important information such as the authentication information (for example, PIN) regarding the client is input, transaction terminal devices 100 and 100A to 100E can receive the input of the authentication information regarding the client after the settlement service certificate is obtained.

Predetermined D signature encryption key SEK according to Exemplary Embodiment 1 is a private key of a manufacturer terminal possessed by the manufacturer of the transaction terminal device, and predetermined D signature decryption key SDK is a public key of the manufacturer terminal possessed by the manufacturer of the transaction terminal device. Thus, since only regular transaction terminal devices 100 or 100A to 100E that store the public key of the manufacturer terminal can decrypt the D signature which is the signature encrypted using the private key of the manufacturer terminal possessed by the manufacturer of the transaction terminal device, transaction terminal devices 100 and 100A to 100E can prevent the signature from being decrypted by a third person who does not possess the public key of the manufacturer terminal.

Both predetermined D signature encryption key SEK and predetermined D signature decryption key SDK according to Exemplary Embodiment 1 are common keys which are previously shared by transaction terminal devices 100 and 100A to 100E and the manufacturer terminal possessed by the manufacturer of the transaction terminal device, and these common keys are stored in the secure storage area (for example, second flash ROM 49) of transaction terminal devices 100 or 100A to 100E. Thus, since only regular transaction terminal devices 100 and 100A to 100E that retain the common keys which are previously shared with the manufacturer terminal decrypt the D signature, transaction terminal device 100 can prevent the D signature from being decrypted by a third person who does not possess the common key. Moreover, since the common key is stored in the secure storage area, it is possible to effectively prevent the common key from being exploited by a third person with malice.

Although it has been described in Exemplary Embodiment 1 that the output value of the hash function is used as an example of the message digest (M digest), the message digest is not limited to the output value of the hash function. For example, a checksum or a fingerprint may be used as the message digest.

It has been described in Exemplary Embodiment 1 that the settlement service certificate is a certificate indicating that processor device 200 is the regular provision destination of the settlement service in the settlement process. However, for example, when transaction terminal devices 100 and 100A to 100E designate a communication connection destination and establish a communication path with the designated counterparty through the secure protocol, the settlement service certificate may be used to determine whether or not the designated counterparty is a legal communication counterparty.

### Exemplary Embodiment 2

In Exemplary Embodiment 2, an example in which a transaction terminal device (settlement terminal device) used in a settlement process of a transaction including the purchase of goods or the provision of services using a card (for example, credit card) possessed by a client is used as an example of a settlement processing device according to the present invention will be described. A settlement processing system according to Exemplary Embodiment 2 includes transaction terminal device 100J of a member store, processor device 200J of an acquirer or a third party, signature generating device 300J of a manufacturer of the transaction terminal device, and electronic certificate managing device 400 of an authentication station. A front view of transaction terminal device 100J according to Exemplary Embodiment 2 is the same as that of transaction terminal device 100 shown in FIG. 4A of Exemplary Embodiment 1. A side view of transaction terminal device 100J according to Exemplary Embodiment 2 is the same as that of transaction terminal device 100 shown in FIG. 4B of Exemplary Embodiment 1. A block diagram showing an example of a hardware configuration of transaction terminal device 100J according to Exemplary Embodiment 2 is the same as that of transaction terminal device 100 shown in FIG. 5 of Exemplary Embodiment 1.

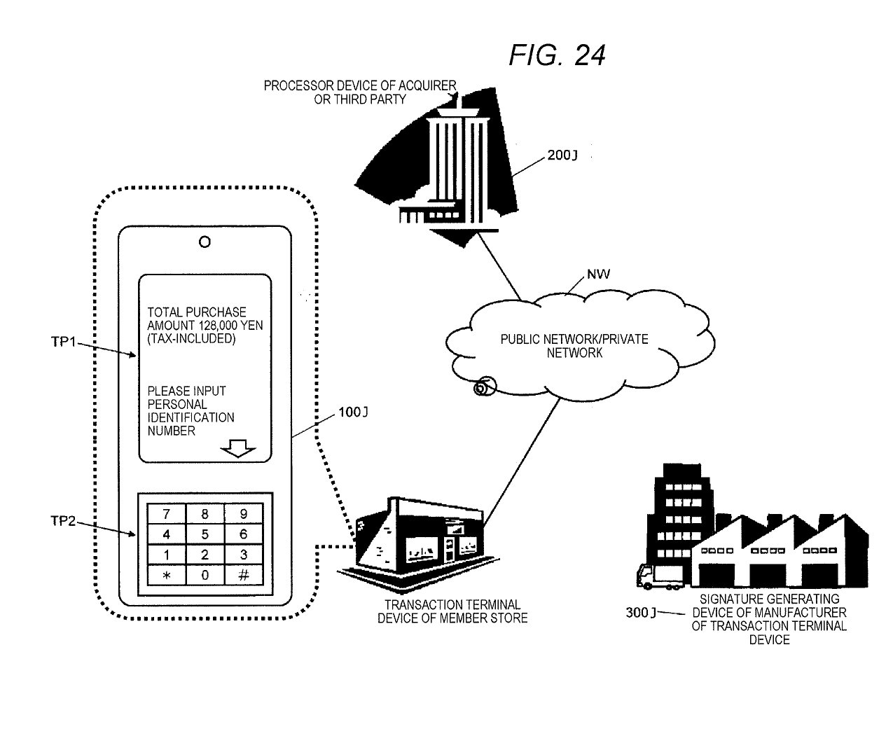

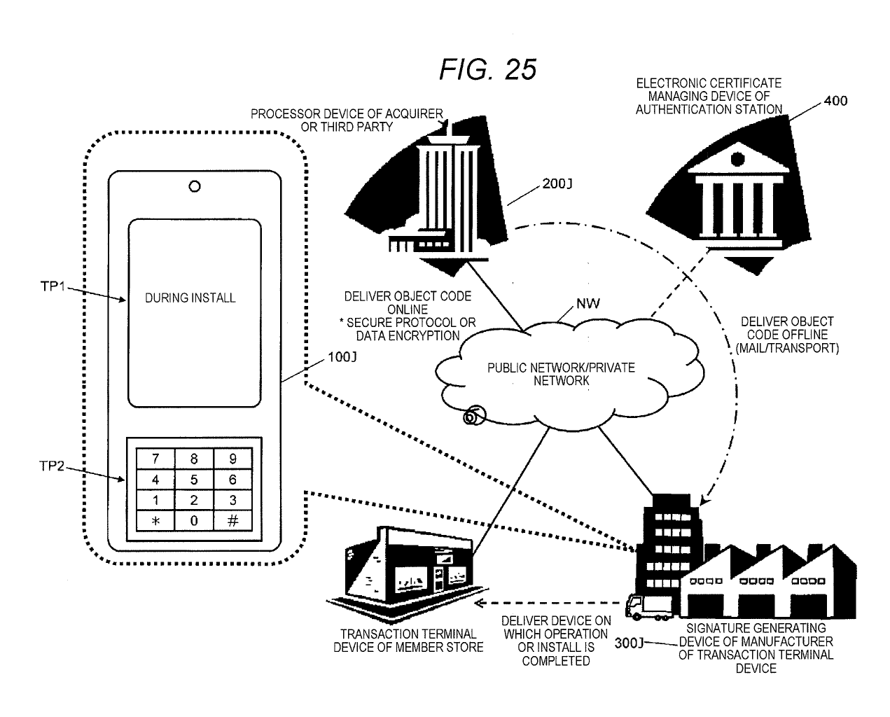

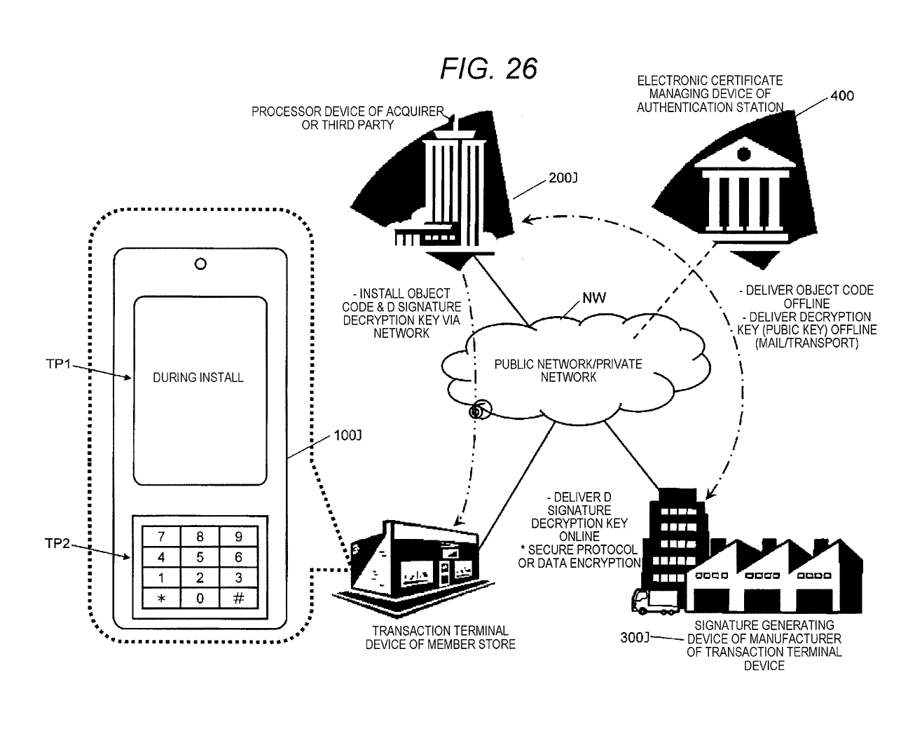

FIG. 24 is a schematic diagram showing the connection relationship between transaction terminal device 100J of the member store, processor device 200J of the acquirer or the third party and signature generating device 300J of the manufacturer of the transaction terminal device at the time of a settlement process. FIG. 25 is a schematic diagram showing a first example of the connection relationship between transaction terminal device 100J of the member store, processor device 200J of the acquirer or the third party, signature generating device 300J of the manufacturer of the transaction terminal device, and electronic certificate managing device 400 of an authentication station at the time of installing a settlement application. FIG. 26 is a schematic diagram showing a second example of the connection relationship between transaction terminal device 100J of the member store, processor device 200J of the acquirer or the third party, signature generating device 300J of the manufacturer of the transaction terminal device, and electronic certificate managing device 400 of the authentication station at the time of installing the settlement application.

Hereinafter, a transaction terminal device of a card member store (for example, store; hereinafter, simply referred to as a “member store”) that carries out transaction using a card is simply referred to as a “transaction terminal device”, a processor device of an acquirer or a third party is simply referred to as a “processor device”, a signature generating device of a manufacturer of a transaction terminal device is simply referred to as a “signature generating device”, and an electronic certificate managing device of an authentication station is simply referred to as an “electronic certificate managing device”. The third party includes a settlement center which carries out an agency task or a mediation task regarding a settlement process between the member store and the acquirer or between the member store and an issuer. The processor device, the signature generating device and the electronic certificate managing device may be configured using, for example, a personal computer (PC).

Public network/private network NW shown in FIGS. 24 to 26 is a wireless network or a wired network. The wireless network is, for example, a wireless local area network (LAN), a wireless wide area network (WAN), 3G, long-term evolution (LTE), or WiGig (Wireless Gigabit). The wired network is, for example, an intranet or the Internet.

In FIG. 24, a case where a settlement process is performed between transaction terminal device 100J and processor device 200J is illustrated, and transaction terminal device 100J and processor device 200J are connected via public network/private network NW. A guide message (for example, “please, input a personal identification number”) regarding an input of a personal identification number (PIN) and a purchase amount (tax included) as a target of the settlement process is displayed on first touch panel TP1 of transaction terminal device 100J. A PIN pad (software key) for inputting the personal identification number (PIN) is displayed on second touch panel TP2 of transaction terminal device 100J.

In FIGS. 25 and 26, in a state where a settlement application is not installed in transaction terminal device 100J, the outline of a procedure of installing a settlement application and starting to use the settlement application is illustrated.

Firstly, in FIG. 25, a program code of the settlement application (hereinafter, referred to as an “object code”) is delivered from processor device 200J to signature generating device 300J offline (that is, the object code is delivered by, for example, mail or transportation without public network/private network NW; the same hereinafter). The object code may be transmitted from processor device 200J to signature generating device 300J online (that is, the object code is transmitted via public network/private network NW; the same hereinafter). In this case, processor device 200J and signature generating device 300J preferably use a secure protocol (for example, secure socket layer (SSL) or IP security protocol (IPsec)), or data encryption.

In FIG. 25, an issuance request for an electronic certificate (for example, a settlement client certificate indicating (guaranteeing) that a settlement application installed in transaction terminal device 100J is a regular settlement application) is transmitted to electronic certificate managing device 400 from signature generating device 300J online. Electronic certificate managing device 400 issues an electronic certificate (for example, the settlement client certificate described above) in response to the issuance request from signature generating device 300J, and transmits the settlement client certificate to signature generating device 300J online.

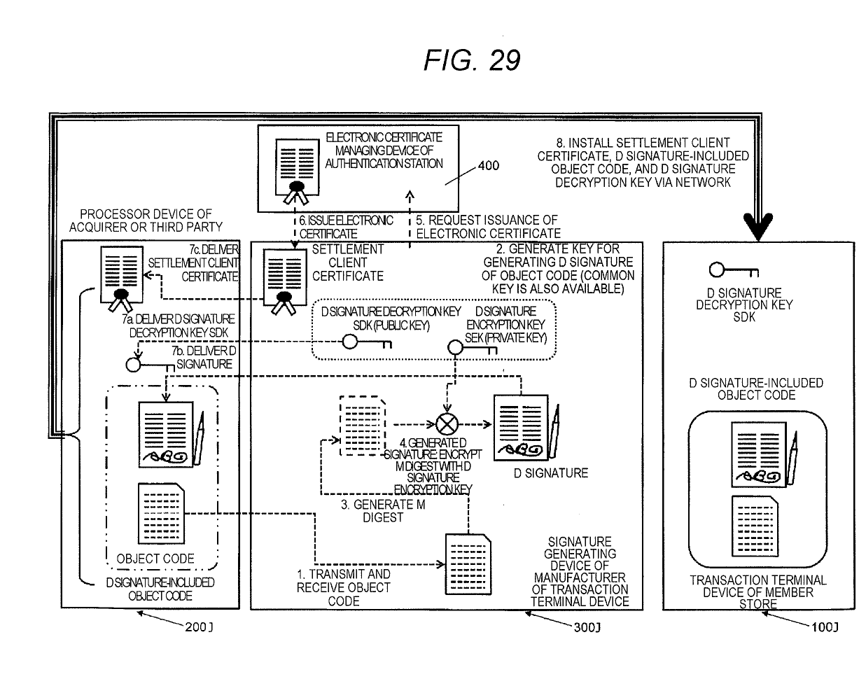

After the object code and the settlement client certificate are received by signature generating device 300J, the manufacturer of the transaction terminal device delivers transaction terminal device 100J in which a predetermined operation or the install operation of the object code is completed to the member store offline. A person in charge of the member store receives transaction terminal device 100J delivered from the manufacturer of the transaction terminal device, provides the received transaction terminal device within the member store, and starts to use the transaction terminal device. Thus, transaction terminal device 100J can obtain the object code, D signature decryption key SDK (see FIG. 29), and the settlement client certificate, and can execute the settlement application.

For example, in FIGS. 25 and 26, a message (for example, “during install”) indicating that the manufacturer of the transaction terminal device is installing the settlement application is displayed on first touch panel TP1 of transaction terminal device 100J. A PIN pad (software key) for inputting the personal identification number (PIN) is displayed on second touch panel TP2 of transaction terminal device 100J.

Meanwhile, in FIG. 26, the object code is delivered from processor device 200J to signature generating device 300J offline. The object code may be transmitted from processor device 200J to signature generating device 300J online. In this case, processor device 200J and signature generating device 300J preferably use a secure protocol (for example, SSL or IPsec), or data encryption.

After the object code is received by signature generating device 300J, D signature decryption key SDK used in a predetermined process (see FIG. 29) is delivered from signature generating device 300J to processor device 200J offline. Signature generating device 300J may transmit D signature decryption key SDK used in the predetermined process (see FIG. 29) to processor device 200J online. In this case, similarly, processor device 200J and signature generating device 300J preferably use a secure protocol (for example, SSL or IPsec), or data encryption.

Similarly to FIG. 25, an issuance request for an electronic certificate (for example, a settlement client certificate indicating (guaranteeing) that a settlement application installed in transaction terminal device 100J is a regular settlement application) is transmitted to electronic certificate managing device 400 from signature generating device 300J online. Electronic certificate managing device 400 issues an electronic certificate (for example, the settlement client certificate described above) in response to the issuance request from signature generating device 300J, and transmits the settlement client certificate to signature generating device 300J online.

Processor device 200J performs a process (copying process) of installing the object code, D signature decryption key SDK and the settlement client certificate in transaction terminal device 100J online (network install). Thus, transaction terminal device 100J can obtain the object code, D signature decryption key SDK and the settlement client certificate, and can execute the settlement application.

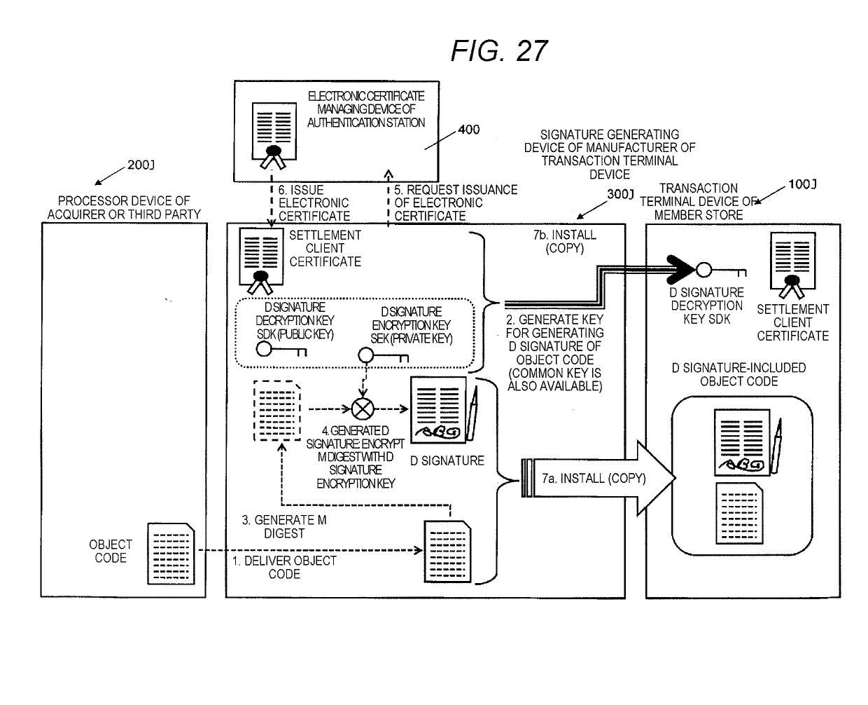

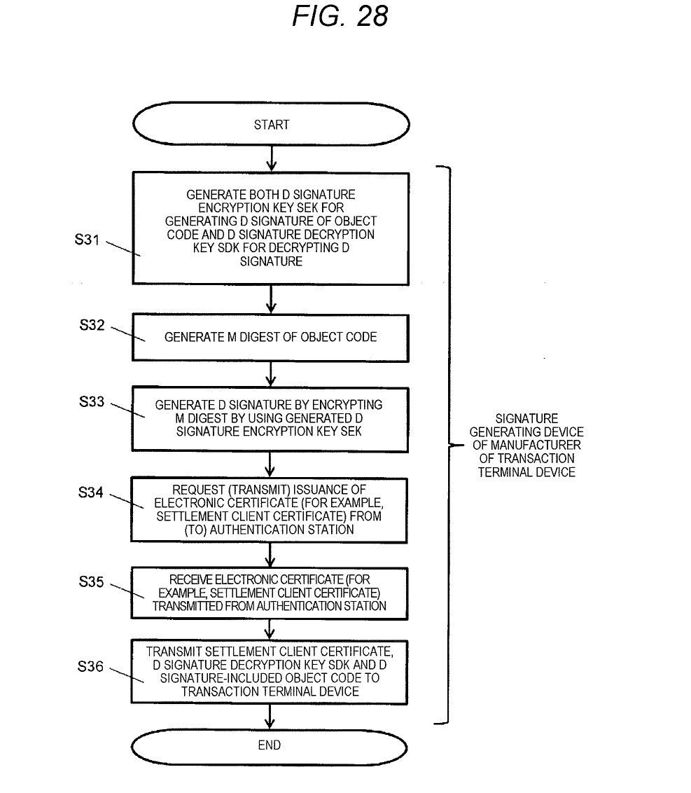

FIG. 27 is an explanatory diagram showing data and the outline of a process flow at the time of installing the settlement client certificate, the D signature decryption key and the D signature-included object code of the settlement application corresponding to FIG. 25. FIG. 28 is a flowchart for describing an operation procedure at the time of installing the settlement client certificate, the D signature decryption key and the D signature-included object code of the settlement application corresponding to FIG. 25. In FIG. 28, an operation procedure of signature generating device 300J is illustrated.

As an assumption in the description of FIGS. 27 to 30, it is assumed that the program code (object code) of the settlement application is not installed in transaction terminal device 100J, and the object code of the settlement application is stored in processor device 200J.

As shown in FIG. 27, processor device 200J delivers or transmits the object code of the settlement application to signature generating device 300J offline or online (see FIG. 25). As described above, when the object code is transmitted online, the secure protocol (for example, SSL or IPsec) is preferably used. When the object code is delivered offline, the object code is delivered to the manufacturer of the transaction terminal device from the acquirer or the third party by mail or transportation. After the object code of the settlement application is obtained from processor device 200J, signature generating device 300J generates both D signature encryption key SEK for generating a D signature (electronic (digital) signature; the same hereinafter.) for indicating that the object code is not illegally modified by a third person with malice and D signature decryption key SDK for decrypting the D signature (S31).

In the following description, although it will be described that the encryption key for generating the D signature and the decryption key for decrypting the D signature are a pair of a private key and a public key according to so-called public-key cryptography, the encryption key and the decryption key may be a single common key which is previously shared by signature generating device 300J and transaction terminal device 100J.

Signature generating device 300J generates a conversion value (for example, a message digest (hereinafter, abbreviated to an M digest)) on a part of or all of the object code by using a predetermined hash function which is previously shared with transaction terminal device 100J (S32). Signature generating device 300J generates the D signature by encrypting the M digest generated in step S32 by using D signature encryption key SEK generated in step S31 (S33).

After the D signature is generated, signature generating device 300J generates the issuance request for the settlement client certificate as an example of a settlement request source certificate, and transmits the generated request to electronic certificate managing device 400 (S34). Electronic certificate managing device 400 issues (generates) the settlement client certificate in response to the issuance request transmitted from signature generating device 300J, and transmits the settlement client certificate to signature generating device 300J. Signature generating device 300J receives the settlement client certificate transmitted from electronic certificate managing device 400 (S35).

Signature generating device 300J delivers or transmits the D signature-included object code obtained by connecting the object code obtained in step S31 and the D signature generated in step S33, and the settlement client certificate received in step S35 to transaction terminal device 100J offline or online (S36) (see FIG. 25). Signature generating device 300J delivers or transmits D signature decryption key SDK generated in step S31 to transaction terminal device 100J offline or online (S36). As described above, when the object code is transmitted online, the secure protocol (for example, SSL or IPsec) is preferably used. Needless to say, when the object code is delivered offline, the object code is delivered from the manufacturer of the transaction terminal device to the member store by mail or transportation.

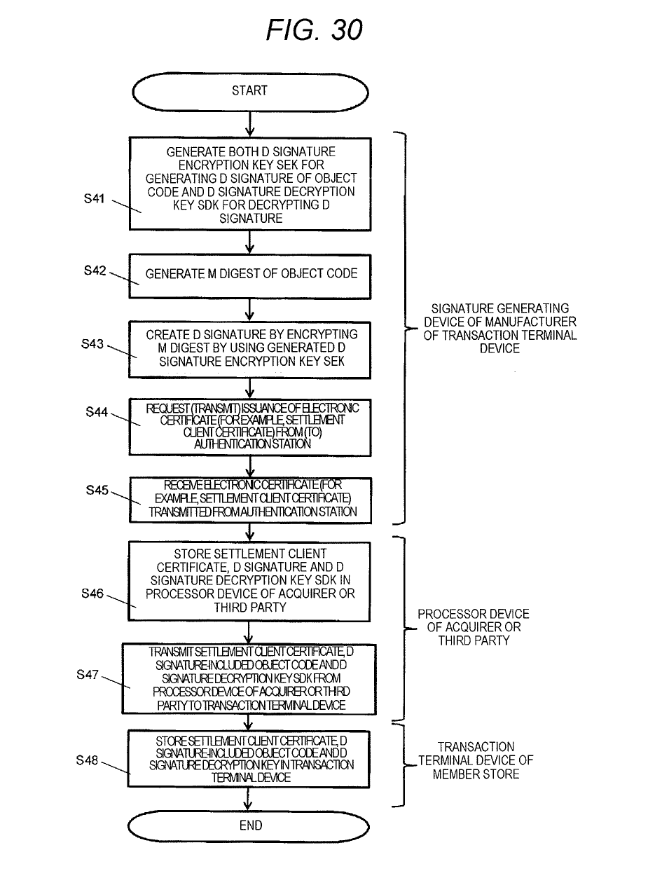

FIG. 29 is an explanatory diagram showing data and the outline of a process flow at the time of installing the settlement client certificate, the D signature decryption key and the D signature-included object code of the settlement application corresponding to FIG. 26. FIG. 30 is a flowchart for describing an operation procedure at the time of installing the settlement client certificate, the D signature decryption key and the D signature-included object code of the settlement application corresponding to FIG. 26. In FIG. 30, an operation procedure of signature generating device 300J, processor device 200J and transaction terminal device 100J is illustrated.

As shown in FIG. 29, processor device 200J delivers or transmits the object code of the settlement application to signature generating device 300J offline or online (see FIG. 26). As described above, when the object code is transmitted online, the secure protocol (for example, SSL or IPsec) is preferably used. When the object code is delivered offline, the object code is delivered to the manufacturer of the transaction terminal device from the acquirer or the third party by mail or transportation. After the object code of the settlement application is obtained from processor device 200J, signature generating device 300J generates both D signature encryption key SEK for generating the D signature for indicating that the object code is not illegally modified by a third person with malice and D signature decryption key SDK for decrypting the D signature (S41).

Signature generating device 300J generates the conversion value (for example, the message digest (hereinafter, abbreviated to the M digest)) on a part of or all of the object code by using the predetermined hash function which is previously shared with transaction terminal device 100J (S42). Signature generating device 300J generates the D signature by encrypting the M digest generated in step S42 by using D signature encryption key SEK generated in step S41 (S43).

After the D signature is generated, signature generating device 300J generates the issuance request for the settlement client certificate as an example of a settlement request source certificate, and transmits the generated request to electronic certificate managing device 400 (S44). Electronic certificate managing device 400 issues (generates) the settlement client certificate in response to the issuance request transmitted from signature generating device 300J, and transmits the settlement client certificate to signature generating device 300J. Signature generating device 300J receives the settlement client certificate transmitted from electronic certificate managing device 400 (S45).

Signature generating device 300J delivers or transmits D signature decryption key SDK generated in step S41, the D signature generated in step S43 and the settlement client certificate received in step S45 to processor device 200J offline or online (S46). As described above, when the object code is transmitted online, the secure protocol (for example, SSL or IPsec) is preferably used. When the object code is delivered offline, the object code is delivered to the acquirer or the third party from the manufacturer of the transaction terminal device by mail or transportation. Processor device 200J stores D signature decryption key SDK, the D signature and the settlement client certificate (S46).

Processor device 200J transmits the D signature-included object code obtained by connecting the D signature and the object code of the settlement application, the D signature decryption key and the settlement client certificate to transaction terminal device 100J online (S47) (see FIG. 26). Transaction terminal device 100J stores the D signature decryption key, the D signature-included object code obtained by connecting the D signature and the object code of the settlement application and the settlement client certificate transmitted from processor device 200J (S48).

In the description of FIGS. 27 to 29, when D signature decryption key SDK is a public key of signature generating device 300J, the D signature decryption key may be stored in any of a non-secure storage area (for example, first flash ROM 33) or a secure storage area (for example, second flash ROM 49) of transaction terminal device 100J. Here, when D signature decryption key SDK is a common key which is previously shared by signature generating device 300J and transaction terminal device 100J, the D signature decryption key may be stored in the secure storage area (for example, second flash ROM 49) of transaction terminal device 100J.

In the description of FIGS. 27 to 29, the D signature-included object code and the settlement client certificate may be stored in any of the non-secure storage area (for example, first flash ROM 33) or the secure storage area (for example, second flash ROM 49) of transaction terminal device 100J.

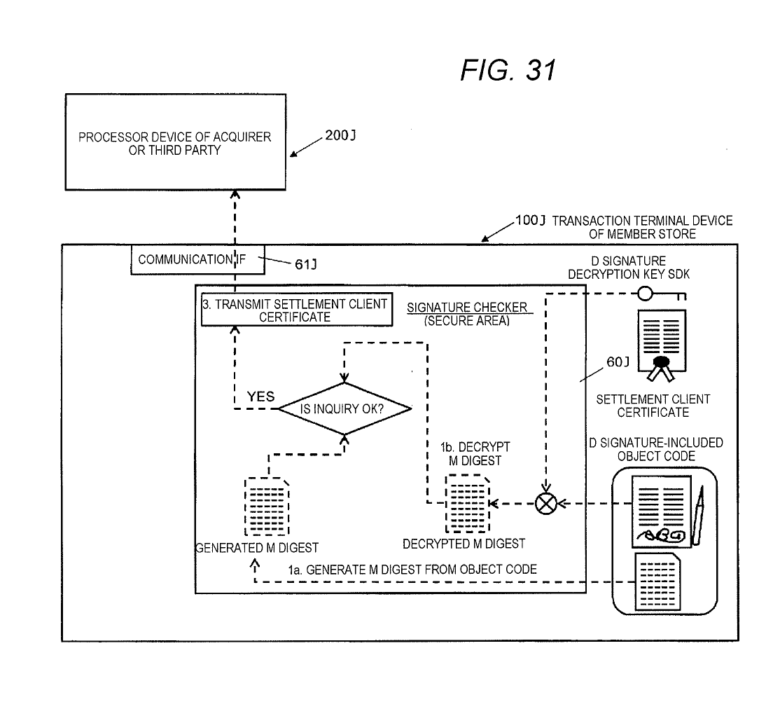

FIG. 31 is an explanatory diagram showing a first example of the operation outline regarding the verification of the D signature, and the transmission of the settlement client certificate in transaction terminal device 100J according to Exemplary Embodiment 2. As an assumption of the description of FIG. 31, it is assumed that transaction terminal device 100J previously stores the D signature-included object code, D signature decryption key SDK, and the settlement client certificate obtained from signature generating device 300J or processor device 200J in first flash ROM 33 or second flash ROM 49, as described in FIGS. 27 to 30.

In FIG. 31, when a predetermined condition is satisfied at the time of performing communication regarding the content of the settlement process with processor device 200J of the acquirer or the third party which is the connection destination of the settlement application, transaction terminal device 100J determines that the settlement client certificate for guaranteeing the reliability that the settlement application installed in transaction terminal device 100J is a regular settlement application that performs the settlement process between the transaction terminal device and processor device 200J is transmitted, and transmits the settlement client certificate to processor device 200J. The predetermined condition is a condition in which the verification of the D signature obtained from processor device 200J or signature generating device 300J succeeds, and the detailed description thereof will be described below. The verification of the D signature is performed by signature checker 60J of transaction terminal device 100J.

Transaction terminal device 100J transmits the settlement client certificate to processor device 200J when the verification of the D signature succeeds, and does not transmit the settlement client certificate to processor device 200J when the verification of the D signature fails. In other words, when communication regarding the content of the settlement process in the settlement application is performed, transaction terminal device 100J determines whether or not to connect to processor device 200J which is the connection destination of the settlement application depending on the determined result (that is, the verified result of the D signature) of whether or not the settlement client certificate is transmitted.

Specifically, in FIG. 31, transaction terminal device 100J extracts the object code from the D signature-included object code stored in first flash ROM 33 or second flash ROM 49, and generates the conversion value (for example, M digest) on a part of or all of the object code by using a predetermined hash function. Transaction terminal device 100J extracts the D signature from the D signature-included object code, and decrypts the D signature by using D signature decryption key SDK stored in first flash ROM 33 or second flash ROM 49. Transaction terminal device 100J determines whether or not the M digest obtained through decrypting coincides with the generated M digest (inquiry).

When it is determined that the M digest obtained through decrypting coincides with the generated M digest (that is, when the verification of the D signature succeeds), transaction terminal device 100J determines that the settlement client certificate is transmitted, and transmits the settlement client certificate to processor device 200J between the transaction terminal device and processor device 200J through communication IF 61J and a secure communication path by using the secure protocol (for example, IPsec or SSL) or data decryption. When it is determined that connection in the settlement process from transaction terminal device 100J is permitted in response to the settlement client certificate transmitted from transaction terminal device 100J, processor device 200J responds to transaction terminal device 100J. Transaction terminal device 100J receives a reply result from processor device 200J through communication IF 61J. After the response result from processor device 200J is received, transaction terminal device 100J performs the settlement process between the transaction terminal device and processor device 200J.

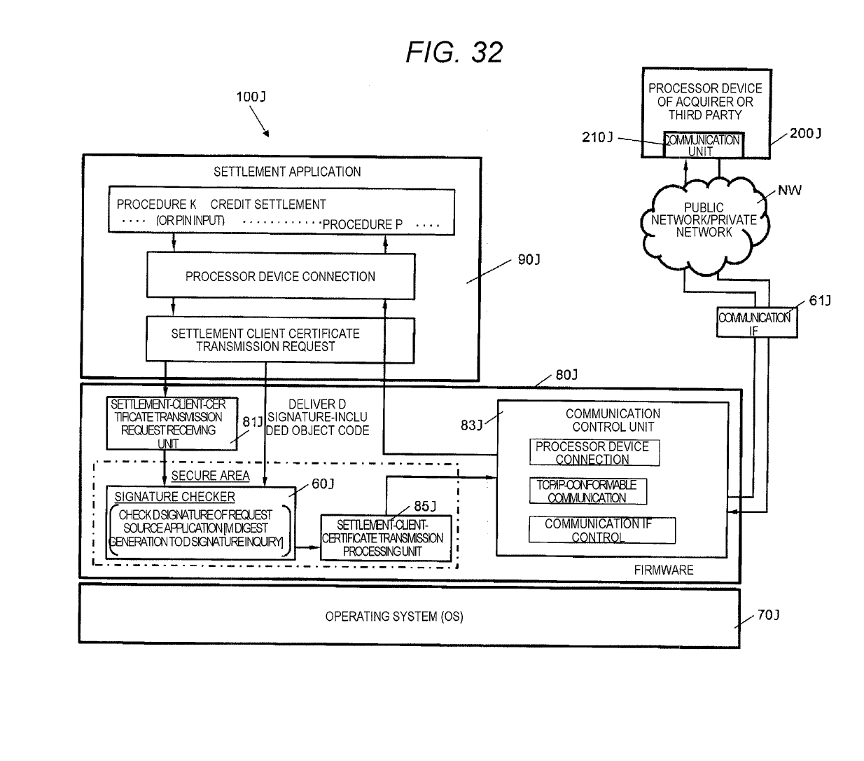

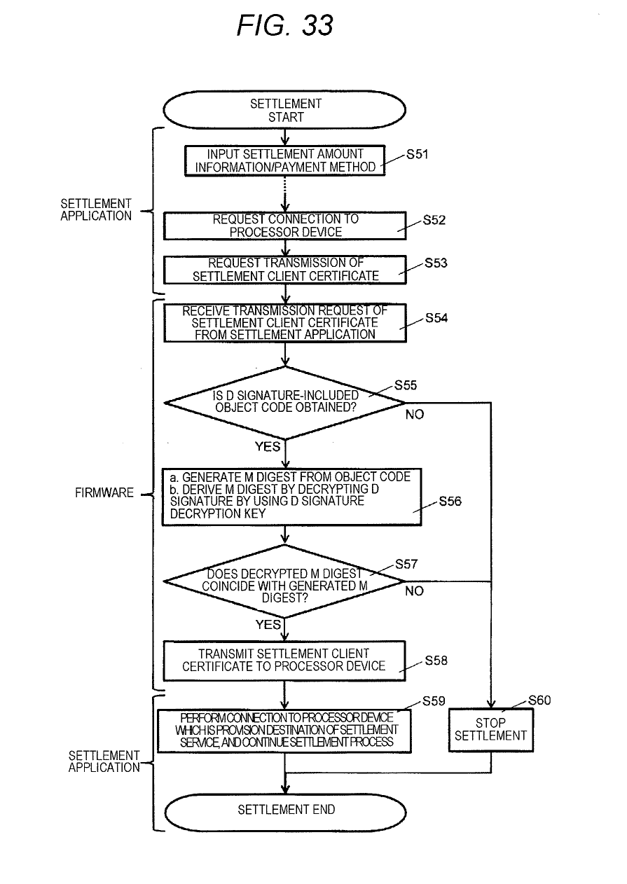

FIG. 32 is a block diagram showing a first example of a functional software configuration of transaction terminal device 100J according to Exemplary Embodiment 2. FIG. 33 is a flowchart for describing a first example of the verification of the D signature, the transmission of the settlement client certificate, and the operation procedure of the settlement process in transaction terminal device 100J corresponding to FIG. 32.

Transaction terminal device 100J shown in FIG. 32 includes at least communication IF 61J, operating system (OS) 70J, firmware 80J operated under operating system 70J, and settlement application 90J operated under firmware 80J. Firmware 80J includes signature checker 60J, settlement-client-certificate transmission request receiving unit 81J, communication control unit 83J, and settlement-client-certificate transmission processing unit 85J.

For example, communication IF 61J is at least one of wide-area wireless communication unit 25 and local wireless communication unit 23, is configured using a circuit conformable to a predetermined communication scheme used by transaction terminal device 100J, and mediates a communication process between communication control unit 83J and public network/private network NW.

Operating system 70J is basic software that controls a basic operation of transaction terminal device 100J.

Settlement-client-certificate transmission request receiving unit 81J receives the request for the transmission of the settlement client certificate from settlement application 90J, and sends the received request to signature checker 60J.

Signature checker 60J as an example of a signature verifying unit is stored in the secure storage area (for example, second flash ROM 49) of transaction terminal device 100J, receives the D signature-included object code from settlement application 90J, and checks (verifies) the D signature of the D signature-included object code in response to the instruction from a request source application (for example, settlement application 90J) which requests the transmission of the settlement client certificate. Specifically, as described with reference to FIG. 31, signature checker 60J generates the M digest for the object code, decrypts the D signature using D signature decryption key SDK, and compares whether or not the M digest obtained through decrypting coincides with the generated M digest. When the verification of the D signature succeeds, signature checker 60J instructs settlement-client-certificate transmission processing unit 85J to perform a transmission process of the settlement client certificate.

Communication control unit 83J performs communication connection with processor device 200J via public network/private network NW, communication control conformable to TCP/IP, and control of communication IF 61J, and transmits the settlement client certificate output from settlement-client-certificate transmission processing unit 85J to processor device 200J through communication IF 61J and public network/private network NW. Communication control unit 83J transmits a response from communication unit 210J of processor device 200J to settlement application 90J.

Settlement-client-certificate transmission processing unit 85J obtains the settlement client certificate from first flash ROM 33 or second flash ROM 49 in response to the instruction from signature checker 60J, and outputs the obtained certificate to communication control unit 83J.

Settlement application 90J as an example of a settlement processing unit is an application which performs the settlement process of the transaction using the card (for example, credit card) possessed by the client. As described with reference to FIGS. 27 to 29, the settlement application can be executed while being delivered or transmitted from signature generating device 300J or processor device 200J and being installed.

For example, during a plurality of procedures (for example, procedure K, . . . , and procedure P) in the settlement (credit settlement) of the transaction using the credit card, settlement application 90J receives input of settlement amount information or a payment method of the transaction, receives input of the authentication information (for example, PIN) of the client, or requests the connection to processor device 200J. In FIG. 32, for example, settlement application 90J outputs the request for the transmission of the settlement client certificate to settlement-client-certificate transmission request receiving unit 81J at the time of requesting the connection to processor device 200J.

Settlement application 90J starts communication (for example, credit inquiry) regarding the content of the settlement process with processor device 200J as a settlement center which is the connection destination device in the settlement process through the acceptance notification from communication control unit 83J.

Processor device 200J includes, for example, at least communication unit 210J. When the settlement client certificate is received from transaction terminal device 100J, processor device 200J outputs the acceptance notification indicating that transaction terminal device 100J which transmits the settlement client certificate is a regular settlement application is permitted in processor device 200J to communication unit 210J. Communication unit 210J transmits (replies) the acceptance notification to transaction terminal device 100J. Since the settlement client certificate is issued (generated) by electronic certificate managing device 400 of the authentication station for each settlement application 90J, the settlement client certificate is stored in processor device 200J in correlation with the settlement application.

In FIG. 33, transaction terminal device 100J executes settlement application 90J installed in, for example, first information processing unit 21, and starts the settlement process. Settlement application 90J receives input of various information items (for example, settlement amount information, payment method, and card brand information used for settlement) regarding the settlement (S51).

After step S51, at the time of requesting the connection to processor device 200J as a settlement center (S52), settlement application 90J generates the request for the transmission of the settlement client certificate, and outputs the generated certificate to settlement-client-certificate transmission request receiving unit 81J (S53).

Settlement-client-certificate transmission request receiving unit 81J receives the request for the transmission of the settlement client certificate from settlement application 90J, and transmits the received request to signature checker 60J (S54). When the D signature-included object code is obtained from settlement application 90J (S55, YES), signature checker 60J extracts the object code from the D signature-included object code, and generates the M digest by using the predetermined hash function. Further, the signature checker decrypts the D signature by using D signature decryption key SDK of settlement application 90J, and derives the M digest (S56).

When it is determined that the generated M digest coincides with the M digest obtained through decrypting (S57, YES), signature checker 60J instructs settlement-client-certificate transmission processing unit 85J to transmit the settlement client certificate. Settlement-client-certificate transmission processing unit 85J obtains the settlement client certificate from first flash ROM 33 or second flash ROM 49 in response to the instruction from signature checker 60J, and outputs the obtained certificate to communication control unit 83J. Communication control unit 83J transmits the settlement client certificate output from settlement-client-certificate transmission processing unit 85J to processor device 200J through communication IF 61J and public network/private network NW (S58). When it is checked that transaction terminal device 100J is a regular request source of the settlement service by using the settlement client certificate which is transmitted from communication control unit 83J of transaction terminal device 100J and is received by communication unit 210J, processor device 200J responds to transaction terminal device 100J. Thus, connection between transaction terminal device 100J and processor device 200J is established. Communication control unit 83J transmits the response from communication unit 210J of processor device 200J to settlement application 90J.

Settlement application 90J receives the response from processor device 200J, and continues to perform the settlement process after step S52 (S59).

Meanwhile, when signature checker 60J does not obtain the D signature-included object code from settlement application 90J (S55, NO) or fails to verify the D signature (that is, when the M digest generated in step S56 does not coincide with the M digest obtained through decrypting) (S57, NO), signature checker 60J omits the request for the transmission of the settlement client certificate, and outputs the instruction that the settlement process in settlement application 90J stops to settlement application 90J (S60). Thus, settlement application 90J stops performing the content of the settlement process of step S52 and the subsequent steps.

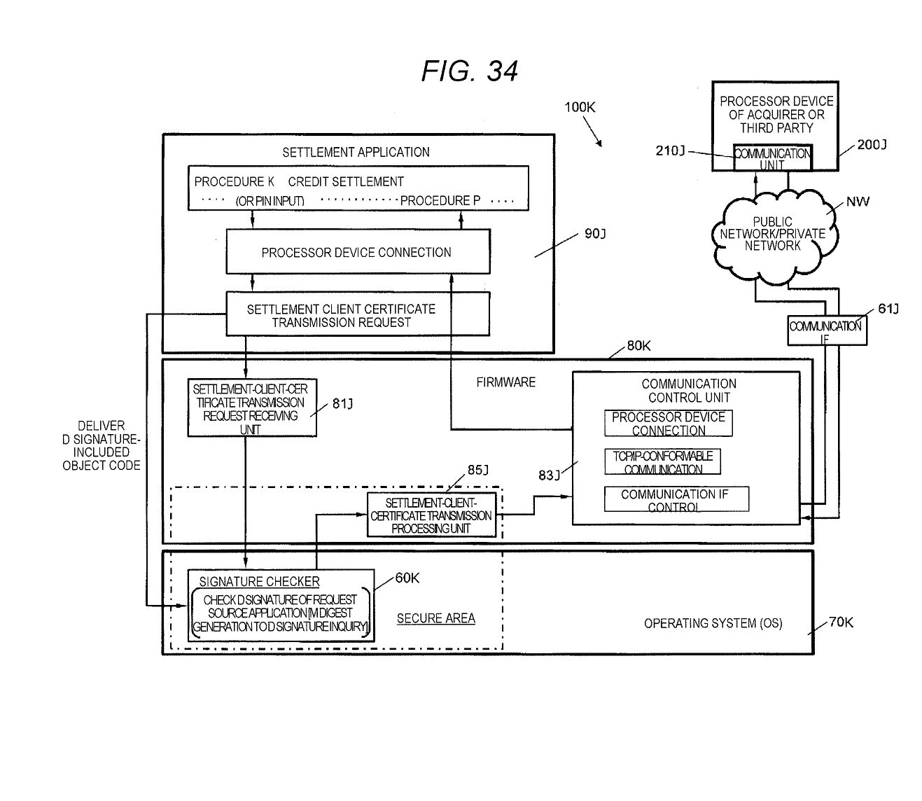

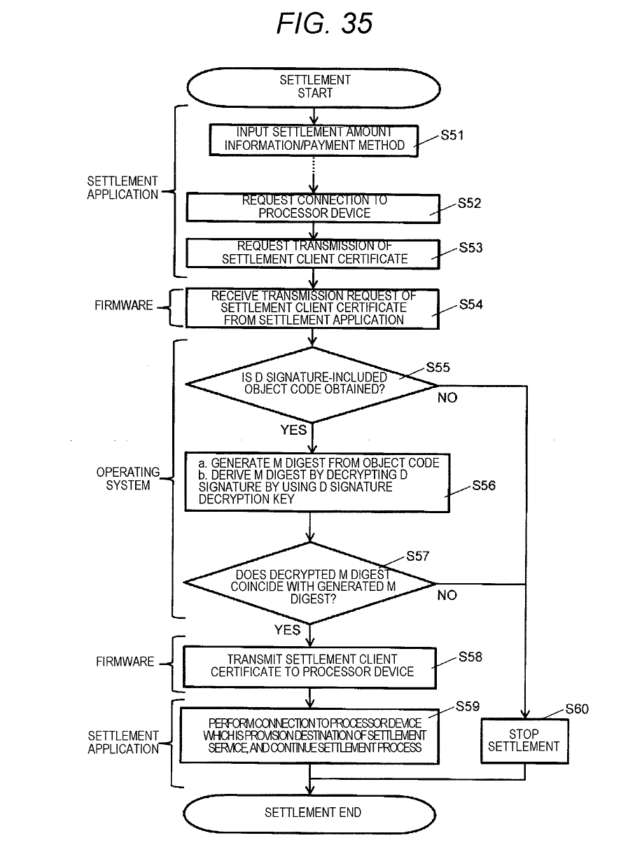

FIG. 34 is a block diagram showing a second example of a functional software configuration of transaction terminal device 100K according to Exemplary Embodiment 2. FIG. 35 is a flowchart for describing a first example of the verification of the D signature, the transmission of the settlement client certificate, and the operation procedure of the settlement process in transaction terminal device 100K corresponding to FIG. 34. In the description of FIGS. 34 and 35, the content different from the content of FIGS. 32 and 33 corresponding thereto will be described, and the description of the same content will be simplified or omitted.

In FIG. 34, signature checker 60K as an example of a signature verifying unit is provided not in firmware 80K but in operating system 70K, and another configuration is the same as that of FIG. 32. In FIG. 35, processes are the same as those of the flowchart shown in FIG. 33 except for the fact that processes from step S55 to step S57 are performed by operating system 70K and step S54 and step S58 are performed by firmware 80K, and thus, the description thereof will be omitted.

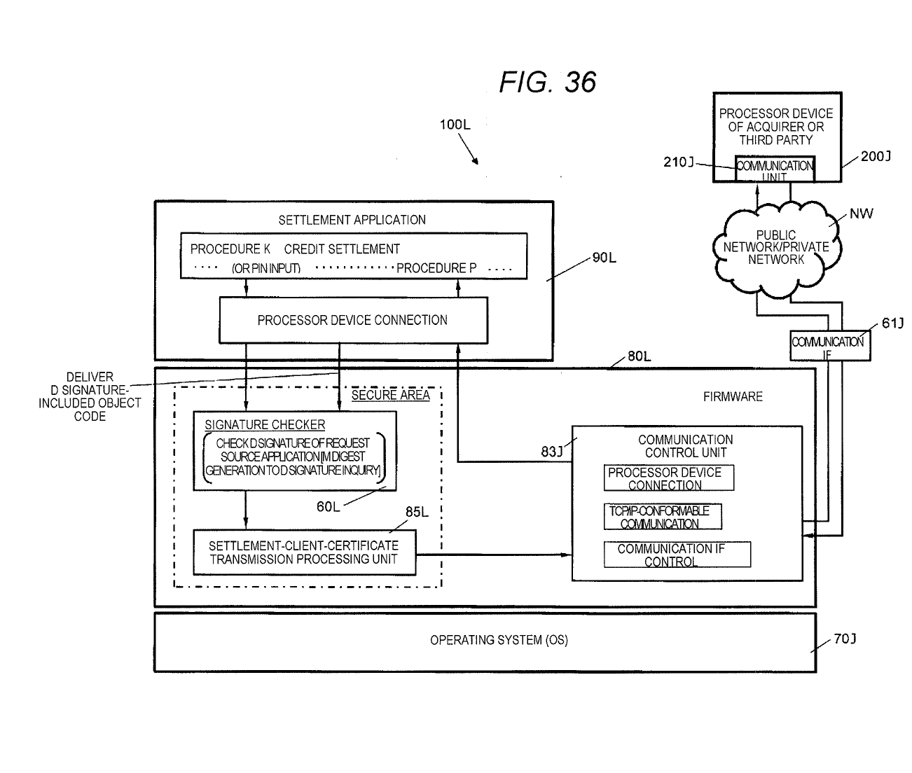

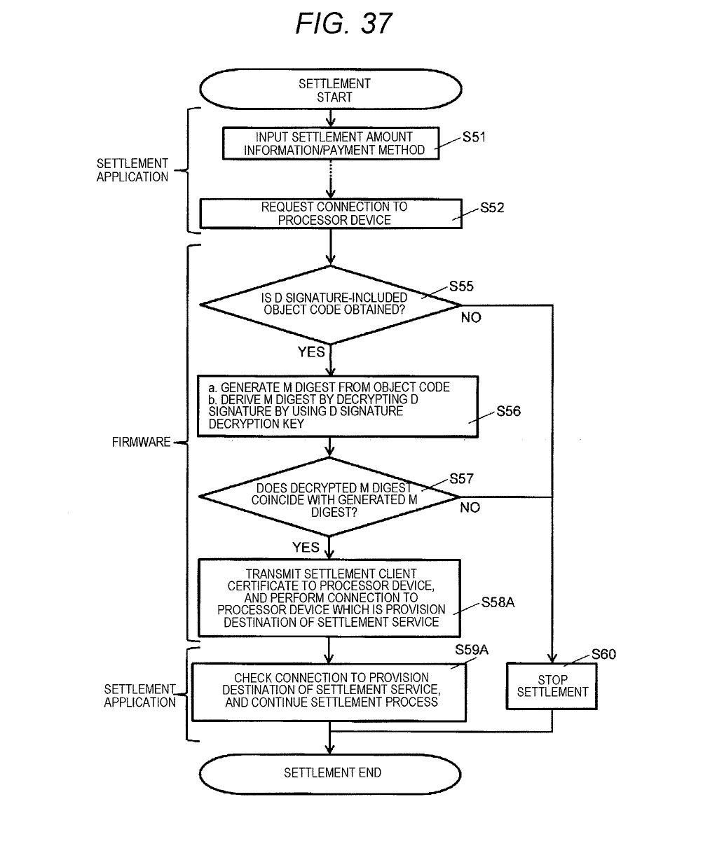

FIG. 36 is a block diagram showing a third example of a functional software configuration of transaction terminal device 100L according to Exemplary Embodiment 2. FIG. 37 is a flowchart for describing a first example of the verification of the D signature, the transmission of the settlement client certificate, and the operation procedure of the settlement process in transaction terminal device 100L corresponding to FIG. 36. In the description of FIGS. 36 and 37, the content different from the content of FIGS. 32 and 33 corresponding thereto will be described, and the description of the same content will be simplified or omitted.

In FIG. 36, although signature checker 60L as an example of a signature verifying unit is provided in firmware 80L, settlement-client-certificate transmission request receiving unit 81J shown in FIG. 32 is omitted, and settlement-client-certificate transmission processing unit 85L is provided. That is, although the request for the transmission of the settlement client certificate is transmitted from settlement application 90J in FIG. 32, the request for the transmission of the settlement client certificate is transmitted from settlement-client-certificate transmission processing unit 85L of firmware 80L in FIG. 36.

Signature checker 60L receives the D signature-included object code from settlement application 90L, and checks (verifies) the D signature in response to the instruction from the request source application (for example, settlement application 90L) which requests communication connection to processor device 200J as a settlement center. A method of checking (verifying) the D signature is the same, and thus, the description thereof will be omitted.

When the verification of the D signature in signature checker 60L succeeds, settlement-client-certificate transmission processing unit 85J obtains the settlement client certificate from first flash ROM 33 or second flash ROM 49 in response to the instruction from signature check 60L, and outputs the generated certificate to communication control unit 83J. Communication control unit 83J transmits the response from communication unit 210J of processor device 200J to settlement application 90L.

In FIG. 37, after settlement application 90L requests communication connection to processor device 200J as a settlement center during the settlement process in step S52, when the D signature-included object code is obtained from settlement application 90L (S55, YES), signature checker 60L extracts the object code from the D signature-included object code, and generates the M digest by using the predetermined hash function. Further, the signature checker decrypts the D signature by using D signature decryption key SDK of settlement application 90L, and derives the M digest (S56).

When it is determined that the generated M digest coincides with the M digest obtained through decrypting (S57, YES), signature checker 60L instructs settlement-client-certificate transmission processing unit 85J to transmit the settlement client certificate (S58A). Thus, settlement-client-certificate transmission processing unit 85J obtains the settlement client certificate from first flash ROM 33 or second flash ROM 49 in response to the instruction from signature checker 60L, and outputs the obtained certificate to communication control unit 83J. When it is checked that transaction terminal device 100J is a regular request source of the settlement service by using the settlement client certificate which is transmitted from communication control unit 83J of transaction terminal device 100J and is received by communication unit 210J, processor device 200J replies to transaction terminal device 100J. Communication control unit 83J transmits the response from communication unit 210J of processor device 200J to settlement application 90J. Thus, connection between transaction terminal device 100J and processor device 200J is established. Settlement application 90J receives the response from processor device 200J, and continues to perform the settlement process (S59A).

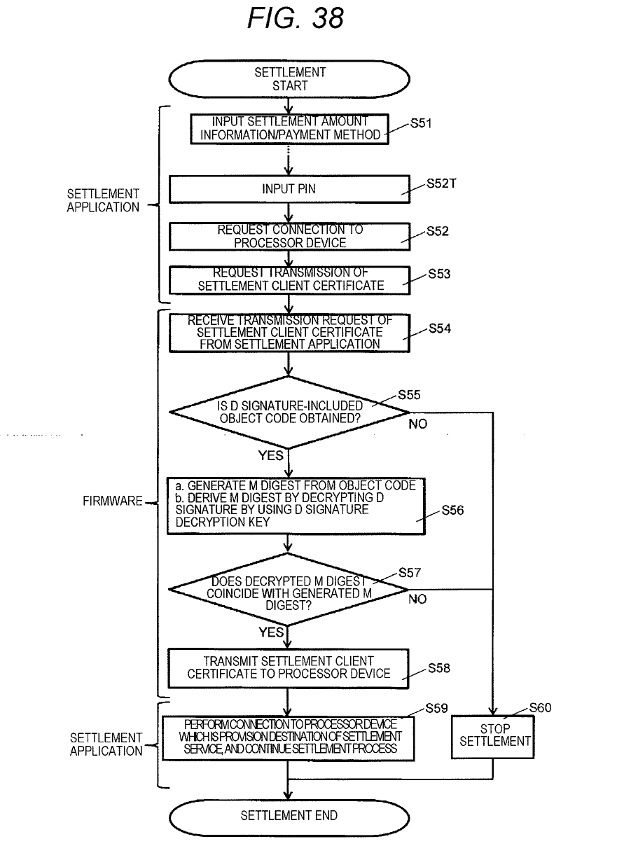

FIG. 38 is a flowchart for describing a second example of the verification of the D signature, the transmission of the settlement client certificate, and the operation procedure of the settlement process in transaction terminal device 100J corresponding to FIG. 33. In the description of FIG. 38, the content different from the content of FIG. 33 will be described, and the description of the same content will be simplified or omitted.

In FIG. 38, after step S51, at a point of time (S52T) when input of an authentication number of the client (for example, personal identification number: PIN) is performed, settlement application 90J requests connection to processor device 200J as a settlement center (S52), generates the request for the transmission of the settlement client certificate, and outputs the generated certificate to settlement-client-certificate transmission request receiving unit 81J (S53). The processes after step S53 are the same as the processes after step S53 shown in FIG. 33, and thus, the description thereof will be omitted.

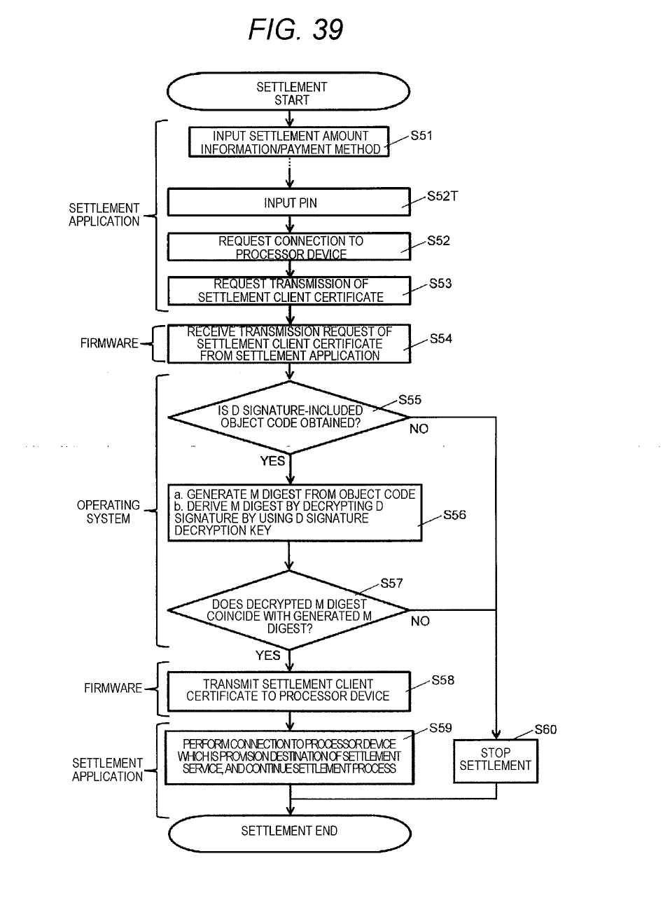

FIG. 39 is a flowchart for describing a second example of the verification of the D signature, the transmission of the settlement client certificate, and the operation procedure of the settlement process in transaction terminal device 100K corresponding to FIG. 35. In the description of FIG. 39, the content different from the content of FIG. 35 will be described, and the description of the same content will be simplified or omitted.

In FIG. 39, after step S51, at a point of time (S52T) when input of the authentication number of the client (for example, personal identification number: PIN) is performed, settlement application 90J requests connection to processor device 200J as a settlement center (S52), generates the request for the transmission of the settlement client certificate, and outputs the generated certificate to settlement-client-certificate transmission request receiving unit 81J (S53). The processes after step S53 are the same as the processes after step S53 shown in FIG. 35, and thus, the description thereof will be omitted.

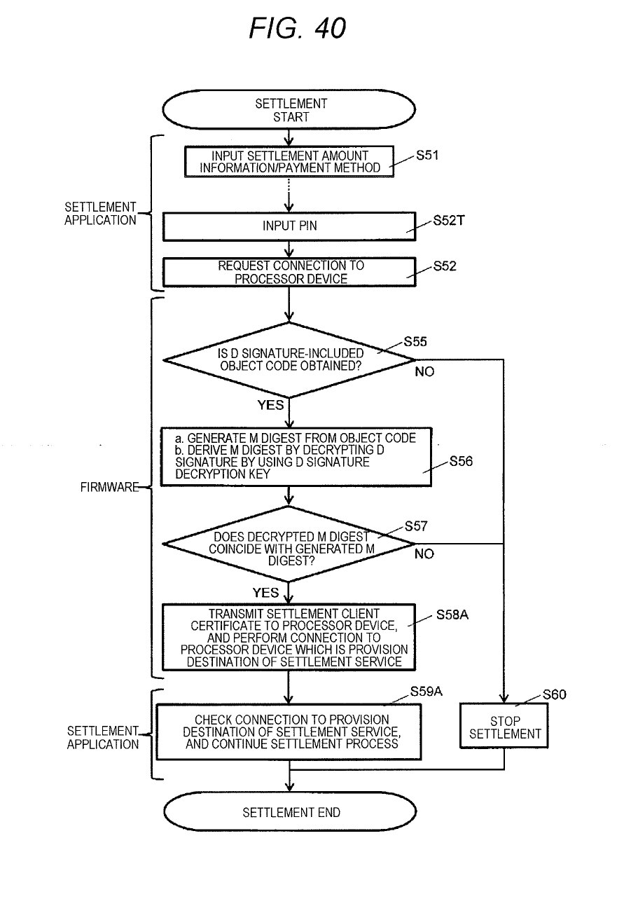

FIG. 40 is a flowchart for describing a second example of the verification of the D signature, the transmission of the settlement client certificate, and the operation procedure of the settlement process in transaction terminal device 100L corresponding to FIG. 37. In the description of FIG. 40, the content different from the content of FIG. 37 will be described, and the description of the same content will be simplified or omitted.

In FIG. 40, after step S51, at a point of time (S52T) when input of the authentication number of the client (for example, personal identification number: PIN) is performed, settlement application 90J requests connection to processor device 200J as a settlement center (S52). The processes after step S52 are the same as the processes after step S52 shown in FIG. 37, and thus, the description thereof will be omitted.

As described above, transaction terminal devices 100J to 100L according to Exemplary Embodiment 2 store the settlement client certificate for indicating the regularity of the connection request source with respect to the connection destination device (settlement destination device) in the settlement process, the D signature obtained by encrypting at least the partial program code of settlement applications 90J to 90L by using predetermined D signature encryption key SEK and predetermined D signature decryption key SDK corresponding to predetermined D signature encryption key SEK in first flash ROM 33 or second flash ROM 49, and verify whether or not the conversion value (for example, the M digest generated using the predetermined hash function) on at least the partial program code of settlement applications 90J to 90L coincides with the decrypted output value (for example, the M digest obtained through decrypting) obtained by decrypting the D signature by using D signature decryption key SDK. When it is verified that the conversion value (generated M digest) on at least the partial program code of settlement applications 90J to 90L coincides with the decrypted output value (for example, the M digest obtained through decrypting) obtained by decrypting the D signature by using D signature decryption key SDK (that is, when neither at least the partial program code of settlement applications 90J to 90L nor D signature decryption key SDK are modified), transaction terminal devices 100J to 100L transmit the settlement client certificate to processor device 200J. Processor device 200J performs the settlement process between transaction terminal devices 100J to 100L and the processor device in response to the settlement client certificate transmitted from transaction terminal devices 100J to 100L.

Thus, depending on the verified result (that is, the verified result of whether or not the conversion value on at least the partial program code of settlement applications 90J to 90L coincides with the decrypted output value obtained by decrypting the D signature by using D signature decryption key SDK) of the regularity of the D signature assigned to at least the partial program code of settlement applications 90J to 90L, transaction terminal devices 100J to 100L can appropriately determine whether or not the settlement client certificate indicating that a connection request source with respect to processor device 200J in the settlement process is a regular connection request source of the settlement service is transmitted.

Transaction terminal devices 100J to 100L can appropriately determine whether or not to connect to processor device 200J depending on whether or not the settlement client certificate is transmitted.

Before communication with processor device 200J in the settlement process between transaction terminal device and processor device 200J starts, transaction terminal devices 100J to 100L instruct signature checkers 60J to 60L to request the transmission of the settlement client certificate. Thus, after the settlement client certificate indicating that the connection request source with respect to processor device 200J is the regular connection request source of the settlement service in the settlement process is obtained, transaction terminal devices 100J to 100L can safely perform communication with processor device 200J.

When input of the authentication information (for example, personal identification number such as PIN) regarding the client in the settlement process between transaction terminal device and processor device 200J is received, transaction terminal devices 100J to 100L instruct signature checkers 60J to 60L to request the transmission of the settlement client certificate. Thus, since it can be determined whether or not to request the transmission for the settlement client certificate before important information such as the authentication information (for example, PIN) regarding the client is input, transaction terminal devices 100J to 100L can safely receive the input of the authentication information regarding the client after the settlement client certificate is transmitted.

Predetermined D signature encryption key SEK according to Exemplary Embodiment 2 is the private key of the manufacturer terminal possessed by the manufacturer of the transaction terminal device, and predetermined D signature decryption key SDK is the public key of the manufacturer terminal possessed by the manufacturer of the transaction terminal device. Thus, since only regular transaction terminal devices 100J to 100L that store the public key of the manufacturer terminal can decrypt the D signature which is the signature encrypted using the private key of the manufacturer terminal possessed by the manufacturer of the transaction terminal device, transaction terminal devices 100J to 100L can prevent the signature from being decrypted by a third person who does not possess the public key of the manufacturer terminal.

Both predetermined D signature encryption key SEK and predetermined D signature decryption key SDK according to Exemplary Embodiment 2 are the common keys which are previously shared by transaction terminal devices 100J to 100L and the manufacturer terminal possessed by the manufacturer of the transaction terminal device, and these common keys are stored in the secure storage area (for example, second flash ROM 49) of transaction terminal devices 100J to 100L. Thus, since only regular transaction terminal devices 100J to 100L that retain the common key which is previously shared with the manufacturer terminal decrypt the D signature, transaction terminal devices 100J to 100L can prevent the D signature from being decrypted by a third person who does not possess the common key. Moreover, since the common key is stored in the secure storage area, it is possible to effectively prevent the common key from being exploited by a third person with malice.

Although it has been described in Exemplary Embodiment 2 that the output value of the hash function is used as an example of the message digest (M digest), the message digest is not limited to the output value of the hash function. For example, a checksum or a fingerprint may be used as the message digest.

It has been described in Exemplary Embodiment 2 that the settlement client certificate is a certificate indicating that the connection request source with respect to processor device 200J in the settlement process is the regular connection request source of the settlement service. However, when the communication path is established through the secure protocol between transaction terminal devices 100J to 100L and processor device 200J, the settlement client certificate may be used to determine whether or not transaction terminal devices 100J to 100L which are a communication counterparty are a legal communication counterparty.

Although various exemplary embodiments have been described with reference to the drawings, it is apparent that the present disclosure is not limited to the exemplary embodiments. It is apparent to those skilled in the art that various modifications or changes are possible without departing from the claims, and it should be understood that these modifications or changes are included in the technical scope of the present disclosure.

1-3. (canceled)

4. A transaction processing system that includes a transaction terminal device, and a settlement destination device that is connected to the transaction terminal device,
wherein the transaction terminal device includes a non-secure first information processing unit that does not have tamper resistance, and a secure second information processing unit that has tamper resistance,
the settlement destination device includes a communication unit that transmits a certificate indicating regularity of the settlement destination device to the transaction terminal device in response to a request from the transaction terminal device,
the first information processing unit includes a settlement processing unit that performs a transaction settlement process, and a certificate request transmitting unit that transmits a request for the certificate to the settlement destination device,
the second information processing unit includes a signature verifying unit that verifies legality of a signature obtained by encrypting at least a part of a program code for operating the settlement processing unit, and
the certificate request transmitting unit transmits the request for the certificate to the settlement destination device when the legality of the signature is verified by the signature verifying unit, and the settlement processing unit performs a settlement process between the settlement destination device and the transaction terminal device by using the certificate transmitted from the settlement destination device.

5. A transaction processing method in a transaction processing system that includes a transaction terminal device which performs a transaction settlement process and a settlement destination device which is connected to the transaction terminal device, the method comprising:
causing the transaction terminal device to include a non-secure first information processing unit that does not have tamper resistance and a secure second information processing unit that has tamper resistance;
causing the transaction terminal device to execute
a step of verifying legality of a signature obtained by encrypting at least a part of a program code of the settlement process in the second information processing unit, and
a step of transmitting a request for a certificate indicating regularity of the settlement destination device to the settlement destination device in the first information processing unit when the legality of the signature is verified in the second information processing unit;
causing the settlement destination device to execute
a step of transmitting the certificate to the transaction terminal device in response to the request from the transaction terminal device; and
causing the transaction terminal device to further execute
a step of performing a settlement process between the settlement destination device and the transaction terminal device in the first information processing unit by using the certificate transmitted from the settlement destination device.

6. A transaction terminal device that is connected to a settlement destination device, the device comprising:
a non-secure first information processing unit that does not have tamper resistance; and
a secure second information processing unit that has tamper resistance,
wherein the first information processing unit includes a settlement processing unit that performs a transaction settlement process, and a certificate request transmitting unit that transmits a request for a certificate indicating regularity of the settlement destination device to the settlement destination device,
the second information processing unit includes a signature verifying unit that verifies legality of a signature obtained by encrypting at least a part of a program code for operating the settlement processing unit, and
the certificate request transmitting unit transmits the request for the certificate to the settlement destination device when the legality of the signature is verified by the signature verifying unit, and the settlement processing unit performs a settlement process between the settlement destination device and the transaction terminal device by using the certificate transmitted from the settlement destination device in response to the request.

7-9. (canceled)

10. A transaction processing system that includes a transaction terminal device, and a settlement destination device connected to the transaction terminal device,
wherein the transaction terminal device includes a non-secure first information processing unit that does not have tamper resistance, and a secure second information processing unit that has tamper resistance,
the settlement destination device includes
a communication unit that performs a settlement process between the transaction terminal device and the settlement destination device in response to a connection request including a certificate indicating regularity of a connection request source with respect to the settlement destination device from the transaction terminal device,
the first information processing unit includes a settlement processing unit that performs a transaction settlement process, and a certificate transmission processing unit that transmits the certificate to the settlement destination device,
the second information processing unit includes a signature verifying unit that verifies legality of a signature obtained by encrypting at least a part of a program code for operating the settlement processing unit, and
the certificate transmission processing unit transmits the certificate to the settlement destination device when the legality of the signature is verified by the signature verifying unit, and the settlement processing unit receives a response result from the settlement destination device in response to the certificate and performs a settlement process between the settlement destination device and the transaction terminal device.

11. A settlement processing method in a transaction processing system that includes a transaction terminal device which performs a transaction settlement process, and a settlement destination device which is connected to the transaction terminal device, the method comprising,
causing the transaction terminal device to include a non-secure first information processing unit that does not have tamper resistance and a secure second information processing unit that has tamper resistance; and
causing the transaction terminal device to execute
a step of verifying legality of a signature obtained by encrypting at least a part of a program code of the settlement process in the second information processing unit,
a step of transmitting a certificate indicating regularity of a connection request source with respect to the settlement destination device to the settlement destination device in the first information processing unit when the legality of the signature is verified in the second information processing unit, and
a step of receiving a response result from the settlement destination device in response to the certificate and performing a settlement process between the settlement destination device and the transaction terminal device.

12. A transaction terminal device that is connected to a settlement destination device, the device comprising:
a non-secure first information processing unit that does not have tamper resistance; and
a secure second information processing unit that has tamper resistance,
wherein the first information processing unit includes a settlement processing unit that performs a transaction settlement process, and
a certificate transmission processing unit that transmits a certificate indicating regularity of a connection request source with respect to the settlement destination device to the settlement destination device,
the second information processing unit includes a signature verifying unit that verifies a signature obtained by encrypting at least a part of a program code of the settlement process, and
the certificate transmission processing unit transmits the certificate to the settlement destination device when the legality of the signature is verified by the signature verifying unit, and the settlement processing unit receives a response result from the settlement destination device in response to the certificate and performs a settlement process between the settlement destination device and the transaction terminal device.
